(19) United States
(12) Patent Application Publication
(10) Pub. No.: US 2025/0151092 A1
(43) Pub. Date: May 8, 2025

(54) METHOD FOR SIDELINK COMMUNICATION AND TERMINAL DEVICE

(71) Applicant: GUANGDONG OPPO MOBILE TELECOMMUNICATIONS CORP., LTD., Dongguan (CN)

(72) Inventors: Shichang ZHANG, Dongguan (CN); Yi DING, Dongguan (CN)

(21) Appl. No.: 19/011,883

(22) Filed: Jan. 7, 2025

Related U.S. Application Data
(63) Continuation of application No. PCT/CN2022/122706, filed on Sep. 29, 2022.

(51) Int. Cl. H04W 72/25; H04W 72/0446; H04W 72/0453

(52) U.S. Cl. CPC H04W 72/25; H04W 72/0446; H04W 72/0453

(57) ABSTRACT

The present application provides methods for sidelink communication, and terminal devices. A method comprises: a terminal device determines a first multi-consecutive slot transmission (MCSt) resource, the first MCSt resource occupying M consecutive slots in a time domain, M being a positive integer greater than 1, and the first MCSt resource satisfying one of the following in frequency domain: occupying one or more resource blocks or interleaved PRBs in a sidelink resource pool; occupying one or more resource block sets in the sidelink resource pool; and occupying one or more sub-channels in the sidelink resource pool.

### CROSS-REFERENCE TO RELATED APPLICATIONS

This application is a continuation of International Application No. PCT/CN2022/122706, filed on Sep. 29, 2022, the disclosure of which is hereby incorporated by reference in its entirety.

### TECHNICAL FIELD

This application relates to the field of communications technologies, and more specifically, to a method for sidelink communication and a terminal device.

### BACKGROUND

In an unlicensed spectrum, a communications device is required to first perform listen before talk (LBT), and then may access a channel after LBT succeeds. When successfully accessing the channel through LBT, the communications device may transmit continuously or discontinuously in a corresponding channel occupancy time (COT). Currently, in order to fully use the COT initiated after the LBT succeeds, a concept of multiple consecutive slot transmission (MCSt) transmission may be introduced in a sidelink over unlicensed spectrum (SL-U) system, that is, a terminal device may transmit continuously in a plurality of slots to improve utilization of the COT. Based on advantages of MCSt, it is discussed currently that the MCSt mode is about to be introduced into the SL-U system. However, how the SL-U system supports MCSt transmission is still an urgent problem to be solved.

### SUMMARY

This application provides a method for sidelink communication and a terminal device. The following describes the aspects related to this application.

According to a first aspect, a method for sidelink communication is provided, including: determining, by a terminal device, a first multiple consecutive slot transmission (MCSt) resource, where the first MCSt resource occupies M consecutive slots in time domain, M is a positive integer greater than 1, and the first MCSt resource meets one of the following in frequency domain: the first MCSt resource occupying one or more resource blocks or interleaved resource block in a sidelink resource pool; the first MCSt resource occupying one or more resource block sets in a sidelink resource pool; or the first MCSt resource occupying one or more sub-channels in a sidelink resource pool.

According to a second aspect, a method for sidelink communication is provided, including: performing, by a terminal device, resource selection in a sidelink resource pool based on a first parameter, where the first parameter is associated with a multiple consecutive slot transmission (MCSt) resource.

According to a third aspect, a terminal device is provided, including: a processing unit, configured to determine a first multiple consecutive slot transmission (MCSt) resource, where the first MCSt resource occupies M consecutive slots in time domain, M is a positive integer greater than 1, and the first MCSt resource meets one of the following in frequency domain: the first MCSt resource occupying one or more resource blocks or interleaved resource block in a sidelink resource pool; the first MCSt resource occupying one or more resource block sets in a sidelink resource pool; or the first MCSt resource occupying one or more sub-channels in a sidelink resource pool.

According to a fourth aspect, a terminal device is provided, including: a processing unit, configured to perform resource selection in a sidelink resource pool based on a first parameter, where the first parameter is associated with a multiple consecutive slot transmission (MCSt) resource.

According to a fifth aspect, a terminal device is provided, including: a processor, a memory, and a communications interface. The memory is configured to store one or more computer programs, and the processor is configured to invoke the computer program in the memory to cause the terminal device to execute some or all of the steps in the method according to the foregoing aspects.

According to a sixth aspect, an embodiment of this application provides a communications system, where the system includes the foregoing terminal device. In another possible design, the system may further include another device that interacts with the terminal device or the network device in the solutions provided in embodiments of this application.

According to a seventh aspect, an embodiment of this application provides a computer-readable storage medium. The computer-readable storage medium stores a computer program. The computer program causes a communications device (for example, a terminal device) to execute some or all of the steps in the method according to the foregoing aspects.

According to an eighth aspect, an embodiment of this application provides a computer program product. The computer program product includes a non-transitory computer-readable storage medium that stores a computer program. The computer program is operable to cause a communications device (for example, a terminal device) to execute some or all of the steps in the method according to the foregoing aspects. In some implementations, the computer program product may be a software installation package.

According to a ninth aspect, an embodiment of this application provides a chip. The chip includes a memory and a processor. The processor may invoke a computer program from the memory and run the computer program, to implement some or all of the steps described in the method according to the foregoing aspects.

### BRIEF DESCRIPTION OF DRAWINGS

FIG. 1 is an example diagram of a system architecture of a wireless communications system to which embodiments of this application are applicable.

FIG. 2 is an example diagram of a scenario of sidelink communication within network coverage.

FIG. 3 is an example diagram of a scenario of sidelink communication with partial network coverage.

FIG. 4 is an example diagram of a scenario of sidelink communication out of network coverage.

FIG. 5 is an example diagram of a scenario of sidelink communication based on a central control node.

FIG. 6 is an example diagram of a broadcast-based sidelink communication manner.

FIG. 7 is an example diagram of a unicast-based sidelink communication manner.

FIG. 8 is an example diagram of a multicast-based sidelink communication manner.

FIG. 9 is a schematic diagram showing a physical layer structure in sidelink communication.

FIG. 10 is a schematic diagram showing another physical layer structure in sidelink communication.

FIG. 11 is a schematic diagram of a method for resource reservation in a sidelink communications system.

FIG. 12 is a schematic diagram of a listening-based resource selection method in a sidelink communications system.

FIG. 13 is a schematic diagram of a listening-based resource selection method in a sidelink communications system.

FIG. 14 is a schematic diagram of a manner of resource mapping on an unlicensed spectrum to which an embodiment of this application is applicable.

FIG. 15 is an example of a resource pool configured on an unlicensed spectrum to which an embodiment of this application is applicable.

FIG. 16 is a schematic flowchart of a method for sidelink communication according to an embodiment of this application.

FIG. 17 is a schematic diagram of a PSFCH resource configuration manner according to an embodiment of this application.

FIG. 18 is a schematic diagram of a PSFCH resource configuration manner according to another embodiment of this application.

FIG. 19 is a schematic diagram of a relationship between a first MCSt resource and a resource in the last symbol in an embodiment of this application.

FIG. 20 is a schematic diagram of a method for sidelink communication according to another embodiment of this application.

FIG. 21 is a schematic diagram of a terminal device according to an embodiment of this application.

FIG. 22 is a schematic diagram of a terminal device according to another embodiment of this application.

FIG. 23 is a schematic structural diagram of a communications apparatus according to an embodiment of this application.

### DESCRIPTION OF EMBODIMENTS

Technical solutions in this application are described below with reference to the accompanying drawings.

### Communications System Architecture

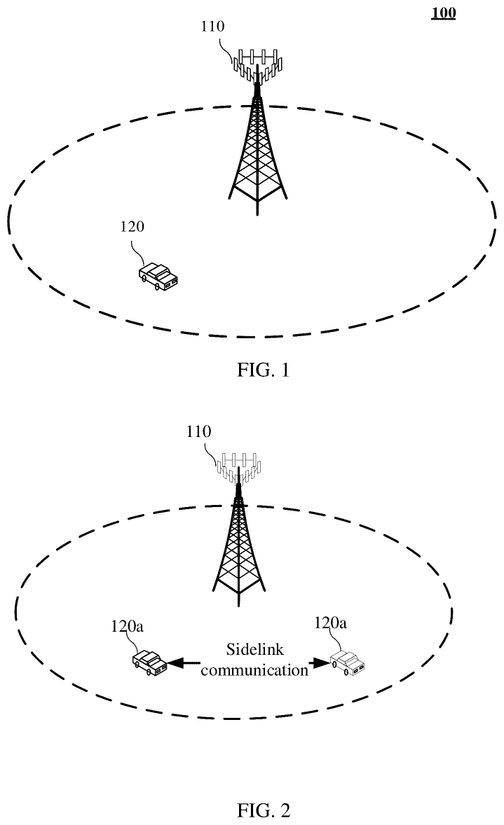

FIG. 1 is an example diagram of a system architecture of a wireless communications system 100 to which an embodiment of this application is applicable. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage.

FIG. 1 shows one network device and one terminal device as an example. Optionally, the wireless communications system 100 may include one or more network devices 110, and/or one or more terminal devices 120. For one network device 110, the one or more terminal devices 120 may be located within network coverage of the network device 110, or may be located out of network coverage of the network device 110, or may be located partially within network coverage of the network device 110, and partially out of the network coverage of the network device 110, which is not limited in embodiments of this application.

Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and an LTE time division duplex (TDD) system. The technical solutions provided in this application may further be applied to a future communications system, such as a 6th generation mobile communications system or a satellite communications system.

The terminal device in embodiments of this application may also be referred to as a user equipment (UE), an access terminal, a subscriber unit, a subscriber station, a mobile site, a mobile station (MS), a mobile terminal (MT), a remote station, a remote terminal device, a mobile device, a user terminal, a wireless communications device, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a vehicle, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. For example, the terminal device may act as a scheduling entity that provides a sidelink signal between terminal devices in vehicle-to-everything (V2X), device-to-device (D2D) communications, or the like. For example, a cellular phone and a vehicle communicate with each other through a sidelink signal. A cellular phone and a smart home device communicate with each other, without relaying a communication signal through a base station. Optionally, the terminal device may be configured to function as a base station.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names below, or may be replaced with the following names, such as a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, V2X, or machine-to-machine (M2M) communications, a network-side device in a 6G network, a device that functions as a base station in a future communications system, or the like. The base station may support networks with a same access technology or different access technologies. A specific technology and a specific device form used by the network device are not limited in embodiments of this application.

The base station may be a fixed or mobile base station. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario of the network device and the terminal device is not limited.

### Sidelink Communication in Different Network Coverage Statuses

Sidelink communication means a sidelink-based communication technology. The sidelink communication may be, for example, device to device (D2D) or vehicle to everything (V2X) communication. Communication data in a conventional cellular system is received or transmitted between a terminal device and a network device, while sidelink communication supports direct communication data transmission between terminal devices. Compared with conventional cellular communication, direct transmission of communication data between terminal devices may have higher spectral efficiency and a lower transmission delay. For example, a vehicle-to-everything system uses a sidelink communication technology.

Sidelink communication may be classified, depending on a network coverage status of the terminal device, into sidelink communication within network coverage, sidelink communication with partial network coverage, and sidelink communication out of network coverage.

FIG. 2 is an example diagram of a scenario of sidelink communication within network coverage. In the scenario shown in FIG. 2, two terminal devices 120a are both located within coverage of a network device 110. Therefore, both the two terminal devices 120a may receive configuration signalling (where the configuration signalling in this application may alternatively be replaced with configuration information) from the network device 110, and determine a sidelink configuration based on the configuration signalling from the network device 110. After performing sidelink configuration, both the two terminal devices 120a may perform sidelink communication on a sidelink.

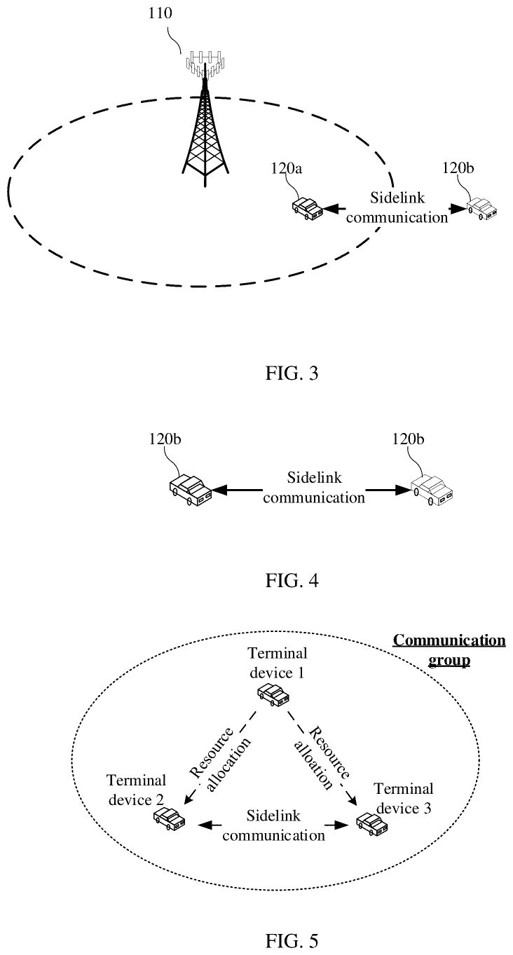

FIG. 3 is an example diagram of a scenario of sidelink communication with partial network coverage. In the scenario shown in FIG. 3, a terminal device 120a performs sidelink communication with a terminal device 120b. The terminal device 120a is located within coverage of a network device 110. Therefore, the terminal device 120a can receive configuration signalling from the network device 110, and determine a sidelink configuration based on the configuration signalling from the network device 110. The terminal device 120b is located out of network coverage, and cannot receive the configuration signalling from the network device 110. In this case, the terminal device 120b may determine a sidelink configuration based on pre-configuration information and/or information that is carried on a physical sidelink broadcast channel (PSBCH) and that is transmitted by the terminal device 120a located within the network coverage. After performing sidelink configuration, both the terminal device 120a and the terminal device 120b may perform sidelink communication on a sidelink.

FIG. 4 is an example diagram of a scenario of sidelink communication out of network coverage. In the scenario shown in FIG. 4, two terminal devices 120b are both located out of network coverage. In this case, both the two terminal devices 120b may determine a sidelink configuration based on pre-configuration information. After performing sidelink configuration, both the two terminal devices 120b may perform sidelink communication on a sidelink.

### Sidelink Communication Based on a Central Control Node

FIG. 5 is an example diagram of a scenario of sidelink communication based on a central control node. In the scenario of sidelink communication, a plurality of terminal devices may form a communication group, and the communication group has a central control node. The central control node may be a terminal device (for example, a terminal device 1 in FIG. 5) in the communication group, and the terminal device may also be referred to as a cluster header (CH) terminal device. The central control node may be responsible for implementing one or more of the following functions: establishing a communication group, adding a group member to or deleting a group member from a communication group, coordinating resources within a communication group, allocating sidelink transmission resources to another terminal device, receiving sidelink feedback information from another terminal device, and coordinating resources with another communication group.

### Mode of Sidelink Communication

Two modes of sidelink communication are defined in some standards or protocols (for example, the 3rd Generation Partnership Project (3GPP)): a first mode and a second mode.

In the first mode, a resource (the resource mentioned in this application may also be referred to as a transmission resource, such as a time-frequency resource) of a terminal device is allocated by a network device. The terminal device may transmit data on a sidelink based on the resource allocated by the network device. The network device may allocate, to the terminal device, a resource for single transmission; or may allocate, to the terminal device, a resource for semi-static transmission. The first mode may be applied to a scenario of being within coverage of a network device, for example, the scenario shown in FIG. 2 described above. In the scenario shown in FIG. 2, the terminal device 120a is located within network coverage of the network device 110. Therefore, the network device 110 may allocate, to the terminal device 120a, a resource used in a sidelink transmission process.

In the second mode, the terminal device may independently select one or more resources from a resource pool (RP). Then, the terminal device may perform sidelink transmission based on the selected resource. For example, in the scenario shown in FIG. 4, the terminal device 120b is located out of cell coverage. Therefore, the terminal device 120b may independently select a resource from a preconfigured resource pool to perform sidelink transmission. Alternatively, in the scenario shown in FIG. 2, the terminal device 120a may independently select one or more resources from a resource pool configured by the network device 110 to perform sidelink transmission.

### Data Transmission Modes of Sidelink Communication

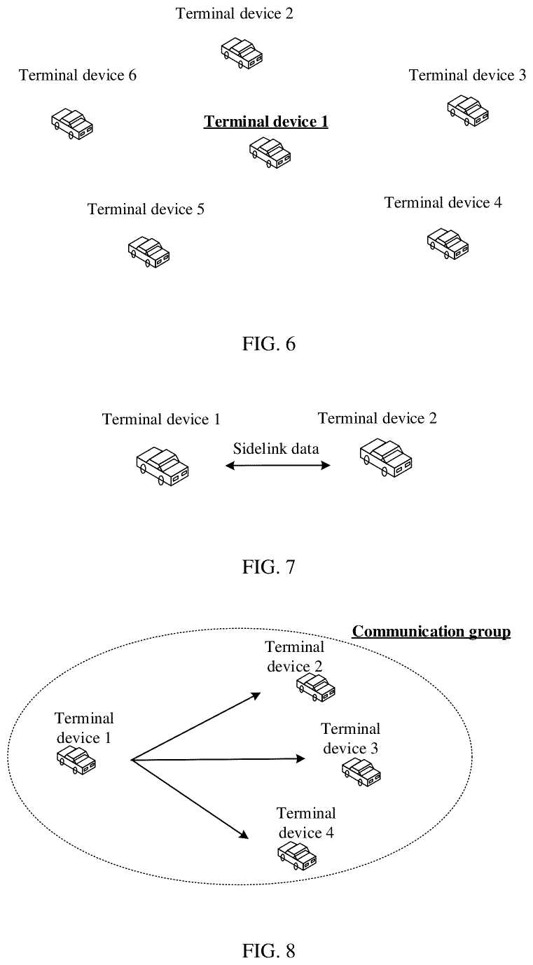

Some sidelink communications systems (such as long term evolution vehicle to everything (LTE-V2X)) support a broadcast-based data transmission mode (briefly referred to as broadcast transmission below). For the broadcast transmission, a receive-end terminal may be any terminal device around a transmit-end terminal. For example, in FIG. 6, a terminal device 1 is a transmit-end terminal, and a receive-end terminal corresponding to the transmit-end terminal is any terminal device around the terminal device 1, for example, may be a terminal device 2 to a terminal device 6 in FIG. 6.

In addition to the broadcast transmission, some communications systems also support a unicast-based data transmission mode (referred to as unicast transmission for short) and/or a multicast-based data transmission mode (referred to as multicast transmission for short). For example, new radio vehicle to everything (NR-V2X) expects to support autonomous driving. Autonomous driving poses higher requirements for data interaction between vehicles. For example, data interaction between vehicles requires a higher throughput, a lower delay, higher reliability, larger coverage, a more flexible resource allocation manner, and the like. Therefore, to improve performance of data interaction between vehicles, NR-V2X is introduced with unicast transmission and multicast transmission.

For the unicast transmission, usually only one terminal device may serve as the receive-end terminal. For example, in FIG. 7, unicast transmission is performed between a terminal device 1 and a terminal device 2. The terminal device 1 may be a transmit-end terminal, and the terminal device 2 may be a receive-end terminal. Alternatively, the terminal device 1 may be a receive-end terminal, and the terminal device 2 may be a transmit-end terminal.

For the multicast transmission, terminal devices in a communication group may serve as the receive-end terminal, or terminal devices within a specific transmission distance may serve as the receive-end terminal. For example, in FIG. 8, a terminal device 1, a terminal device 2, a terminal device 3, and a terminal device 4 constitute a communication group. If the terminal device 1 transmits data, all the other terminal devices (the terminal device 2 to the terminal device 4) in the group may be receive-end terminals.

### Physical Layer Structure of Sidelink Communication

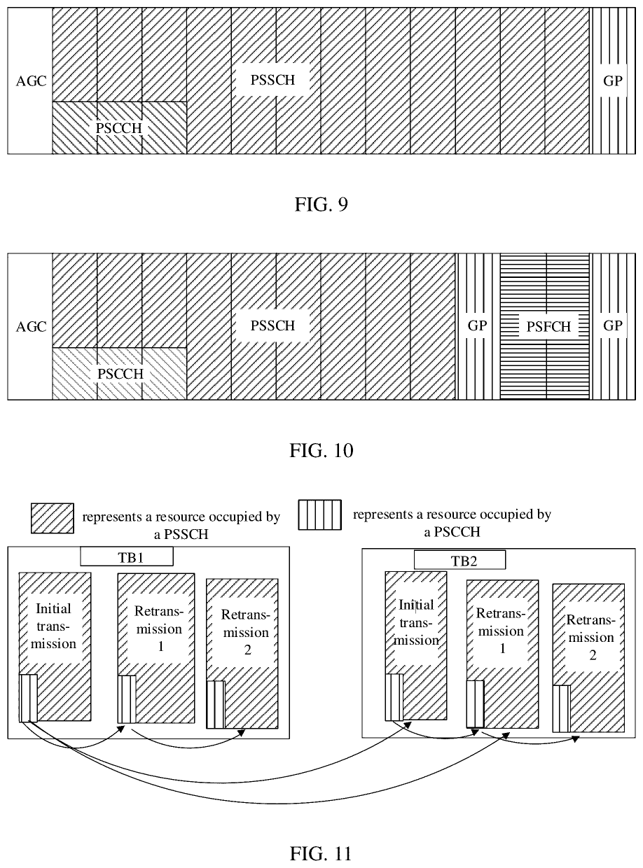

With reference to FIG. 9 and FIG. 10, the following describes a frame structure of a sidelink system frame to which embodiments of this application are applicable. FIG. 9 shows a frame structure of a system frame that does not carry a physical sidelink feedback channel (PSFCH) in NR-V2X. FIG. 10 shows a frame structure of a system frame that carries a PSFCH in NR-V2X.

Referring to FIG. 10, in time domain, a PSCCH occupies two or three sidelink symbols starting from the second sidelink symbol (for example, an orthogonal frequency division multiplexing (OFDM) symbol) of a system frame. In frequency domain, the physical sidelink control channel (PSCCH) may occupy {10, 12 15, 20, 25} physical resource blocks (PRB). Generally, to reduce complexity of blind detection performed by a terminal device on the PSCCH, only one PSCCH symbol quantity and only one PRB quantity are allowed to be configured in one resource pool. In addition, because a sub-channel is a minimum granularity for PSSCH resource allocation specified in NR-V2X, a quantity of PRBs occupied by a PSCCH must be less than or equal to a quantity of PRBs included in one sub-channel in the resource pool, to avoid additional limitation on resource selection or allocation of the physical sidelink shared channel (PSSCH).

Still referring to FIG. 9, in time domain, a PSSCH also starts from the second sidelink symbol of a system frame, and ends at the last but one sidelink symbol of the system frame. In frequency domain, the PSSCH occupies K1 sub-channels of the system frame, where each sub-channel includes K2 consecutive PRBs, and K1 and K2 are positive integers.

Generally, the last symbol of the system frame is a guard period (GP) symbol. In addition, the first sidelink symbol of the system frame is a repetition of the second sidelink symbol. Generally, when receiving the system frame, a terminal may use the first sidelink symbol as an automatic gain control (AGC) symbol. Generally, data on the AGC symbol is not used for data demodulation.

As shown in FIG. 10, in one slot, the first OFDM symbol is fixed for automatic gain control (AGC). On the AGC symbol, a UE copies information transmitted on the second symbol. The last symbol of the slot is a guard period, which is used for switching between reception and transmission, that is, for the UE to switch from a transmit (or receive) state to a receive (or transmit) state. In remaining OFDM symbols, a PSCCH may occupy two or three OFDM symbols starting from the second sidelink symbol. In frequency domain, PRBs occupied by the PSCCH are in a range of one sub-channel of the PSSCH. If a quantity of PRBs occupied by the PSCCH is less than that of one sub-channel of the PSSCH, or a frequency domain resource of the PSSCH includes a plurality of sub-channels, on the OFDM symbols on which the PSCCH is located, the PSCCH may be frequency-division-multiplexed with the PSSCH.

The PSCCH is used to carry first-stage SCI that mainly includes a field related to resource listening, which facilitates another UE to perform resource exclusion and resource selection after decoding. In addition to data, the PSSCH further carries second-stage SCI, and the second-stage SCI mainly includes a field related to data demodulation, which facilitates another UE to demodulate data in the PSSCH.

In NR-V2X, a PSFCH resource is periodically configured, and the period may be {0, 1, 2, 4} slots. If the period is 0, it indicates that no PSFCH resource is configured in a current resource pool. When the period is 2 or 4 slots, a system resource occupied by a PSFCH may be reduced. If there is a PSFCH resource in a slot, the PSFCH is located in the last-but-one OFDM symbol in the slot. Since receiving power of a UE may change on an OFDM symbol where the PSFCH is located, the last-but-two symbol in the slot will also be used for transmission of the PSFCH, to assist a receive UE in AGC adjustment. A signal on the last-but-two symbol is a repetition of a signal on the last-but-one symbol. In addition, a UE transmitting a PSSCH may be different from a UE transmitting a PSFCH. Therefore, an additional symbol is required before two PSFCH symbols for switching between reception and transmission of a UE.

### Resource Reservation of Sidelink Communication

With reference to the foregoing descriptions of the modes of sidelink communication, in the second mode, a terminal device may independently select a sidelink resource to transmit data. Resource reservation may be understood as a prerequisite for allowing the terminal device to perform resource selection. Resource reservation means that the terminal device may reserve a selected sidelink resource (for example, a time-frequency resource) in first sidelink control information carried in a PSCCH.

Currently, in a sidelink communications system, not only intra-TB resource reservation but also inter-TB resource reservation is allowed. The following provides a description with reference to FIG. 11.

Referring to FIG. 11, the terminal device transmits first sidelink control information (SCI), and indicates, by using a time resource assignment field and a frequency resource assignment field in the first SCI, N time-frequency resources (including a time-frequency resource used for transmission of a current transport block (TB)) used for transmission of a current TB. Generally, N≤Nmax. In NR V2X, Nmax is equal to 2 or 3. In addition, the foregoing N indicated time-frequency resources may be distributed in W slots. In NR V2X, W is equal to 32.

Still referring to FIG. 11, in a process of transmitting a TB 1, the terminal device may transmit the first SCI in a PSCCH while transmitting initial transmission data in a PSSCH, and indicate time-frequency resource positions for initial transmission and retransmission 1 (that is, N=2 in this case) by using the foregoing two fields in the first SCI, that is, reserve a time-frequency resource for retransmission 1. Generally, initial transmission and retransmission 1 are distributed in 32 slots in time domain.

Similarly, still referring to FIG. 11, in the process of transmitting the TB 1, the terminal device may indicate time-frequency resources for retransmission 1 and retransmission 2 by using the first SCI transmitted in the PSCCH of retransmission 1. The time-frequency resources for retransmission 1 and retransmission 2 may be distributed in 32 slots in time domain.

In addition, when transmitting the first SCI, the terminal device may perform inter-TB resource reservation by using a resource reservation period field in the first SCI.

Still referring to FIG. 11, when transmitting the first SCI that indicates an initial transmission resource of the TB 1, the terminal device may indicate the time-frequency resource positions for initial transmission and retransmission 1 of the TB 1 by using the time resource assignment field and the frequency resource assignment field in the first SCI, which are denoted as {(t1, f1), (t2, f2)}, where t1 and t2 denote time domain positions of resources for initial transmission and retransmission 1 of the TB 1; and f1 and f2 denote frequency domain positions of the resources for initial transmission and retransmission 1 of the TB 1. If a value of the resource reservation period field in the first SCI is 100 milliseconds, the first SCI indicates both time-frequency resources {(t1+100, f1), (t2+100, f2)}. The two resources are used for initial transmission and retransmission 1 of a TB 2.

Similarly, the first SCI transmitted on the resource for retransmission 1 of the TB 1 may also reserve, by using the resource reservation period field, time-frequency resources for retransmission 1 and retransmission 2 of the TB 2. In NR V2X, possible values of the resource reservation period field are 0 milliseconds, 1 to 99 milliseconds, 100 milliseconds, 200 milliseconds, 300 milliseconds, 400 milliseconds, 500 milliseconds, 600 milliseconds, 700 milliseconds, 800 milliseconds, 900 milliseconds, and 1000 milliseconds, which are more flexible than those in LTE V2X. However, in each resource pool, generally, only e of the values are configured. The terminal device may determine, based on the resource pool, values that may be used. The e values in a configuration of the resource pool are denoted as a resource reservation period set M. For example, e is less than or equal to 16.

In addition, the foregoing inter-TB reservation may be activated or deactivated on a resource pool basis via network configuration or pre-configuration. When the inter-TB reservation is deactivated, the first SCI does not include the resource reservation period field. Generally, a value of the resource reservation period field used by the terminal device, i.e., a resource reservation period, does not change before resource reselection is triggered. Each time the terminal device transmits the first SCI, the terminal device reserves, by using the resource reservation period field in the first SCI, a resource for a next period for transmitting another TB, thereby achieving periodic semi-persistent transmission.

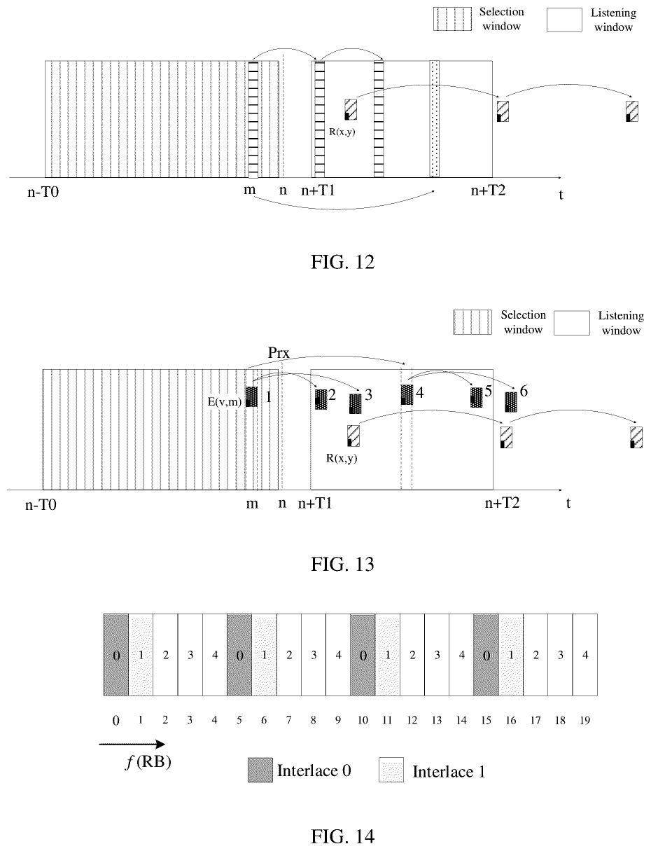

When the terminal device operates in the foregoing second mode, the terminal device may obtain, by listening to a PSCCH transmitted by another terminal device, first SCI transmitted by the another terminal device, thereby learning a resource reserved by the another terminal device. When performing resource selection subsequently, the terminal device excludes the resource reserved by the another terminal device, thereby avoiding resource collision. The following describes a listening-based resource selection method in a sidelink communications system with reference to FIG. 12 and FIG. 13.

### Listening-Based Resource Selection Method

Referring to FIG. 12, a terminal device may trigger resource selection or reselection in a slot n. In some implementations, the slot n may be a slot in which a higher layer (for example, a MAC layer) triggers a physical layer to report a candidate resource set. A resource selection window starts from n+T₁ and ends at n+T₂, and is represented as [n+T₁, n+T₂], where 0≤T₁≤T_{proc,1}; when subcarrier spacing is 15 kHz, 30 kHz, 60 kHz, or 120 kHz, T_{proc,1} is 3 slots, 5 slots, 9 slots, or 17 slots, respectively; T_{2 min}≤T₂≤Remaining delay budget of a service; a value set of T_{2 min} is {1, 5, 10, 20} *2μ slots; and u being 0, 1, 2, or 3 corresponds to a case in which the subcarrier spacing is 15 kHz, 30 kHz, 60 kHz, or 120 kHz, respectively. The terminal device determines T_{2 min} from the value set based on a priority of data to be transmitted by itself. For example, when the subcarrier spacing is 15 kHz, the terminal device determines T_{2 min} from the set {1, 5, 10, 20} based on the priority of data to be transmitted by itself. When T_{2 min} is greater than or equal to the remaining delay budget of the service, T₂ is equal to the remaining delay budget of the service. The remaining delay budget is a difference between a current instant and an instant corresponding to a delay requirement of the data. For example, for a data packet arriving in the slot n, the delay requirement is 50 milliseconds. It is assumed that one slot is 1 millisecond. If the current instant is the slot n, the remaining delay budget is 50 milliseconds. If the current instant is a slot n+20, the remaining delay budget is 30 milliseconds.

Before resource selection, the terminal device is required to perform resource listening in a listening window ranging from n−T₀ to n−T_{proc,0}, where a value of T₀ is 100 milliseconds or 1100 milliseconds. When the subcarrier spacing is 15 kHz, 30 kHz, 60 kHz, or 120 kHz, T_{proc,0} is 1 slot, 1 slot, 2 slots, or 4 slots, respectively. Generally, a terminal device listens, in each slot (except its own transmitting slot), to first SCI transmitted by another terminal device. If resource selection or reselection is triggered in the slot n, the terminal device may use results of resource listening performed at n−T₀ to n−T_{proc,0}. The following describes a resource selection process with reference to step 1 and step 2.

In step 1 (Step 1), the terminal device uses, as a resource set A (hereinafter referred to as a “candidate resource set”), all candidate available resources that belong to a resource pool used by the terminal device and are in the resource selection window.

In some implementations, the terminal device may use, as the resource set A, all available resources that belong to the resource pool used by the terminal device and are in the resource selection window. Any resource in a single slot in the resource set A is denoted as R(x,y), where x and y indicate a frequency domain position and a time domain position of the resource respectively, and R(x,y) represents one or more consecutive sub-channels starting from a sub-channel y in slot x. An initial quantity of resources in the resource set A is denoted as Mtotal. The terminal device may perform resource exclusion on the resource set A based on an unlistened slot in a resource listening window (case 1-1) and/or a resource listening result in the resource listening window (case 1-2). A terminal determines whether a resource R(x, y) or a series of periodic resources corresponding to resource R(x, y) overlaps with a slot determined based on the unlistened slot in case 1-1 or a resource determined based on listened first sidelink control information in case 1-2. If they overlap, the resource R(x, y) is excluded from the resource set A.

The following describes case 1-1 and case 1-2.

Case 1-1: If the terminal transmits data but does not perform listening in a slot m in the listening window, the terminal determines corresponding Q slots based on the slot m and each allowed resource reservation period in the resource pool used by the terminal, each allowed resource reservation period being used as an interval. If the Q slots overlap with the resource R(x, y) or a series of periodic resources corresponding to the resource R(x, y), the resource R(x, y) will be excluded from the resource set A, where Q=1 or Q=[Tscal/Prx] (┌ ┐ means ceiling operation). Tscal is equal to a value of T₂ in the unit of millisecond; and Prx is one of the resource reservation periods allowed for the resource pool used by the terminal. Optionally, the series of periodic resources corresponding to the resource R(x, y) are Cᵣₑₛₑₗ resources with a same frequency domain position as R(x, y) and a fixed time interval in time domain, where Cᵣₑₛₑₗ is related to a random count value generated by the terminal, for example, the time interval is determined based on a resource reservation period Ptx of the terminal. For example, FIG. 12 shows a case where Cᵣₑₛₑₗ is 3, indicating three periodic resources (including R(x, y)) corresponding to the resource R(x, y).

For example, in FIG. 12, the terminal does not perform listening in slot m, and performs resource exclusion successively based on each resource reservation period in the resource reservation period set M in a resource pool configuration that is used. For a specific resource reservation period 1, assuming that a calculated value of Q is 2, corresponding Q slots are the next two slots that are mapped from slot m in FIG. 12 with resource reservation period 1 as an interval and that are marked with horizontal line shadows. For a specific resource reservation period 2, assuming that a calculated value of Q is 1, a corresponding Q slot is the next slot that is mapped from slot m in FIG. 12 with resource reservation period 2 as an interval.

The terminal determines whether Q slots corresponding to respective reservation periods overlap with the resource R(x, y) or the series of periodic resources corresponding to the resource R(x, y). If they overlap, the resource R(x, y) will be excluded from the resource set A.

Optionally, when reservation between TBs is deactivated for the resource pool used by the terminal, the terminal may not perform the case 1-1.

Optionally, after the case 1-1 is performed, if a quantity of remaining resources in the resource set A is less than X*Mtotal, the resource set A is initialized to all available resources belonging to the resource pool used by the terminal in the resource selection window, and then the case 1-2 is further performed.

Case 1-2: If in a slot m in the listening window, first sidelink control information transmitted in a PSCCH is detected, the terminal measures a sidelink reference signal received power (SL-RSRP) of the PSCCH or an SL-RSRP of a PSSCH scheduled by the PSCCH (i.e., an SL-RSRP of a PSSCH corresponding to the PSCCH and transmitted in a same slot as the PSCCH).

If the measured SL-RSRP is greater than an SL-RSRP threshold, and SCI received by the UE includes a resource reservation period field, the terminal determines the corresponding Q slots based on the slot m and the resource reservation period carried in the detected first sidelink control information, with the resource reservation period as an interval. The terminal assumes that the first sidelink control information with same content is also received in the Q slots. The terminal will determine whether resources indicated in “time resource assignment” and “frequency resource assignment” fields of the first sidelink control information received in the slot m and Q first sidelink control information assumed to be received overlap with the resource R (x, y) or the series of periodic resources corresponding to the resource R (x, y). If they overlap, the corresponding resource R (x, y) is excluded from the set A, where Q=1 or Q=[Tscal/Prx]. Tscal is equal to a value of T₂ in the unit of millisecond; and Prx is the resource reservation period carried in the detected first sidelink control information. Optionally, the series of periodic resources corresponding to the resource R(x, y) are Cᵣₑₛₑₗ resources with a same frequency domain position as R(x, y) and a fixed time interval in time domain, where Cᵣₑₛₑₗ is related to a random count value generated by the terminal, for example, the time interval is determined based on a resource reservation period Ptx of the terminal. For example, FIG. 13 shows a case where Cᵣₑₛₑₗ is 3, indicating three periodic resources corresponding to the resource R(x,y) (it should be noted that the resource R(x,y) is included in the three periodic resources).

Referring to FIG. 13, when the SCI received by a UE includes a resource reservation period field, if the terminal detects the first sidelink control information in a PSCCH on a resource E (v, m) in the slot m, the resource reservation period in the first sidelink control information is Prx. Assuming that a calculated value of Q is 1, the terminal will assume that the first sidelink control information with same content is also received in a next slot (namely, the slot where resource 4 is located) from the slot m with an interval of Prx. The terminal will determine whether resources 1, 2, 3, 4, 5, and 6 indicated in “Time resource assignment” and “Frequency resource assignment” fields of the first sidelink control information received in the slot m and the first sidelink control information assumed to be received overlap with the resource R (x, y) or the series of periodic resources corresponding to the resource R (x, y). If they overlap and an RSRP condition is met, the resource R (x, y) is excluded from the resource set A.

If the SL-RSRP measured by the terminal is greater than the SL-RSRP threshold and the SCI received by the terminal does not include a resource reservation period field, the terminal only determines whether resources indicated in “Time resource assignment” and “Frequency resource assignment” fields of the first sidelink control information received in the slot m overlap with the resource R(x, y) or the series of resources corresponding to the resource R(x, y). If they overlap, the resource R(x, y) is excluded from the resource set A.

Still referring to FIG. 13, when the SCI received by the terminal does not include the resource reservation period field, if the terminal detects the first sidelink control information in a PSCCH on resource E(v, m) in the slot m, the terminal determines whether resources 1, 2, 3 indicated in “Time resource assignment” and “Frequency resource assignment” fields in the first sidelink control information overlap with the resource R(x, y) or the series of periodic resources corresponding to the resource R(x, y). If they overlap and the RSRP condition is met, the resource R(x, y) is excluded from the resource set A.

If a quantity of remaining resources in the resource set A after the resource exclusion are less than Mtotal*X, the SL-RSRP threshold is raised by 3 dB and step 1 is performed again. The physical layer reports the resource set A after resource exclusion as the candidate resource set to the higher layer.

Step 2: The higher layer randomly selects a resource from the reported candidate resource set to transmit data. In other words, the terminal device randomly selects a resource from the candidate resource set to transmit data.

In some implementations, step 1 may be performed by a physical layer of the terminal device, and accordingly, the high layer in step 2 may be a high layer relative to the physical layer, for example, a MAC layer.

In the resource selection process, the following points are to be noted.

1. It should be noted that the RSRP threshold is determined based on a priority P1 carried in a PSCCH detected by the terminal and a priority P2 of data to be transmitted by the terminal. The configuration of the resource pool used by the terminal includes an SL-RSRP threshold table, which includes SL-RSRP thresholds corresponding to all priority combinations. The configuration of the resource pool may be configured by a network, or preconfigured.

When detecting a PSCCH transmitted by another UE, the terminal obtains a priority P1 carried in first sidelink control information transmitted in a PSCCH and a priority P2 of data to be transmitted, and determines the SL-RSRP threshold by looking up Table 1.

2. Whether a measured PSCCH-RSRP or a PSSCH-RSRP scheduled by the PSCCH is used by the terminal to be compared with the SL-RSRP threshold depends on a resource pool configuration of the resource pool used by the terminal. The configuration of the resource pool may be configured by a network, or preconfigured.

3. For the X, possible values of X are {20%, 35%, 50%}. The configuration of the resource pool used by the terminal includes a correspondence between priorities and the foregoing possible values. The terminal determines a value of X based on the correspondence and a priority of data to be transmitted. The resource pool configuration may be configured by a network or pre-configured.

The above introduction describes an SL communication method in NR-V2X, that is, a terminal independently selects transmission resources through resource listening and transmits data on sidelink. This SL communication method may also be applied to various SL communications such as direct communication between handheld terminals and direct communication between pedestrians and vehicles.

### Unlicensed Spectrum

An unlicensed spectrum is a spectrum that is specified by a country or a region for communication of a radio device. The spectrum is generally considered as a shared spectrum. In other words, communications devices in a same communications system or different communications systems may use the spectrum provided that a regulatory requirement set for the spectrum specified by the country or the region is met, and there is no need to apply for a dedicated spectrum grant from a government.

To enable various communications devices (or communications systems) that perform wireless communication by using an unlicensed spectrum to coexist on the spectrum, some countries or regions stipulate regulatory requirements to be met for using the unlicensed spectrum. For example, a communications device follows a rule of “listen before talk (LBT)”. The so-called LBT means that a communications device is required to perform channel listening (sensing) first before transmitting a signal on a channel of an unlicensed spectrum. If a channel listening result indicates that the channel is idle, the communications device is allowed to transmit signals by using the channel of the unlicensed spectrum. If a channel listening result indicates that the channel is busy, the communications device is generally not allowed to transmit signals by using the channel of the unlicensed spectrum.

Signal transmission in the unlicensed spectrum involves concepts related to channel occupancy, such as channel occupancy time (COT), maximum channel occupancy time (MCOT), COT of a network device (such as a base station), and COT of a terminal device.

MCOT may mean a maximum time length during which a communications device is allowed to transmit signals by using a channel of an unlicensed spectrum if LBT succeeds. It should be understood that MCOT refers to a time period occupied by signal transmission. Different channel access priority classes (CAPC) for a communications device may correspond to different MCOTs. A maximum value of the MCOT may be set to, for example, 10 ms.

COT may mean a time length during which a channel of an unlicensed spectrum is used to transmit signals after LBT succeeds. Within a time length corresponding to a COT, a channel occupied by a signal may be discontinuous in time domain. Generally speaking, one COT cannot exceed 20 ms at most. In addition, a time length of signal transmission in a COT should not exceed MCOT.

The COT of a network device is also referred to as a network device-initiated COT. For example, if the network device is gNB, the COT of the network device may be referred to as a gNB-initiated COT. The COT of a network device may mean a channel occupancy time obtained by the network device after LBT succeeds. In addition to being used for downlink transmission, the channel occupancy time of the network device may be used for uplink transmission of a terminal device under a specific condition.

The COT of a terminal device is also referred to as a terminal device-initiated COT. For example, if the terminal device is a UE, the COT of a terminal device may be referred to as a UE-initiated COT. The COT of a terminal device may mean a channel occupancy time obtained by the terminal device after LBT succeeds.

### Channel Access Methods for Unlicensed Spectrum or Shared Spectrum

A channel access method of accessing a channel through LBT is introduced in some communications systems (such as an NR-U system). In addition, the communications systems may also support channel access through short control signaling transmission (SCSt). The foregoing two channel access methods are introduced below.

The basic concept of LBT has been introduced in the foregoing description. The following mainly introduces several different types of LBT modes (namely, several different types of channel access methods based on LBT).

An LBT mode of type 1 (Type 1 LBT mode) may also be referred to as multi-slot channel detection with random backoff based on contention window size adjustment. In the Type 1 LBT mode, a communications device may initiate channel occupation with a length of T_{mcot} based on a channel access priority p. If a network device uses the Type 1 LBT mode, the network device can transmit its own data during a channel occupation time, and also can share the COT with a terminal device. The so-called sharing of the COT with a terminal device means allowing the terminal device to transmit data in a time length corresponding to the COT (namely, a COT obtained by the network device through channel access). Correspondingly, if the terminal device uses the Type 1 LBT mode, the terminal device can transmit its own data during a channel occupation time, and also can share the COT with the network device. The following table shows channel access priorities and corresponding parameters used when the terminal device performs the Type 1 LBT mode.

TABLE 1
Channel access parameters corresponding
to different channel priorities

| p | mₚ | CW_{min, p} | CW_{max, p} | T_{mcot, p} | | Allowed CWₚ value |
|---|---|---|---|---|---|---|
| 1 | 2 | 3 | 7 | 2 | ms | {3, 7} |
| 2 | 2 | 7 | 15 | 4 | ms | {7, 15} |
| 3 | 3 | 15 | 1023 | 6 or 10 | ms | {15, 31, 63, 127, |
| | | | | | | 255, 511, 1023} |
| 4 | 7 | 15 | 1023 | 6 or 10 | ms | {15, 31, 63, 127, |
| | | | | | | 255, 511, 1023} |

In the foregoing Table 1, mₚ denotes a quantity of backoff slots corresponding to a channel access priority p, CWₚ denotes a contention window size corresponding to the channel access priority p, CW_{min,p} denotes a minimum value of CWₚ corresponding to the channel access priority p, CW_{max,p} denotes a maximum value of CWₚ corresponding to the channel access priority p, and T_{mcot,p} denotes a maximum occupancy time length of a channel corresponding to the channel access priority p. In the four channel access priorities in Table 1, p=1 is the highest priority.

An LBT mode of Type 2 (Type 2 LBT mode) may also be referred to as a channel access manner based on a fixed-length channel monitoring slot. The Type 2 LBT mode includes an LBT mode of Type 2A (Type 2A LBT mode), an LBT mode of Type 2B (Type 2B LBT mode), and an LBT mode of Type 2C (Type 2C LBT mode).

In the Type 2A LBT mode, the communications device may perform single-slot channel detection of 25 μ s. In other words, the communications device may start channel detection ahead of transmission of data by 25 us. The channel detection of 25 us may include channel detection of 16 μs and channel detection of 9 μs. If both detection results indicate that a channel is idle, it may be considered that the channel is idle and channel access can be performed.

In the Type 2B LBT mode, the communications device may perform single-slot channel detection of 16 μs. In a channel detection process, if the communications device detects that a channel is idle for more than 4 μs in the last 9 μs, it may be considered that the channel is idle.

In the Type 2C LBT mode, the communications device may transmit data directly through a channel without channel detection. In the Type 2C LBT mode, a time difference between a current transmission and a previous transmission is less than or equal to 16 μs. In other words, if the time difference between two transmissions is less than or equal to 16 μs, the two transmissions may be considered as a same transmission and channel detection is not required. It should be noted that, in the Type 2C LBT mode, transmission duration of the communications device is limited and usually cannot exceed 584 μs.

The channel access manner based on LBT is described above, and the following will introduce SCSt. In an unlicensed spectrum, in order to improve a success rate of a communications device accessing a channel for transmitting control signaling, SCSt is introduced. SCSt is a transmission of a communications device without sensing whether there is another signal on the channel. For example, SCSt is a transmission of management and control frames by a communications device without sensing whether there is another signal on the channel. In other words, when a communications device adopts SCSt, the communications device may access a channel for transmission without performing channel listening. However, use of SCSt is required to meet a specific condition. For example, if a communications device expects to access a channel by using SCSt, the communications device is required to meet one or more of the following conditions: in an observation period of 50 ms, a number of times of using SCSt is less than or equal to 50; or in an observation period of 50 ms, duration of SCSt does not exceed 2.5 ms.

It should be noted that, generally, LBT is also referred to as channel access, type 1 LBT mode may be referred to as type 1 channel access mode, type 2A LBT mode may be referred to as type 2A channel access mode, type 2B LBT mode may be referred to as type 2B channel access mode, and type 2C LBT mode may be referred to as type 2C channel access mode. In embodiments of this application, LBT and channel access may be interchangeable.

### Resource Block Set in an SL-U System

For the NR SL technology working on the unlicensed spectrum, regulatory requirements in related regions are required to be considered in system design, such as occupied channel bandwidth (OCB) and power spectral density (PSD). For example, for an unlicensed spectrum in the 5 GHz band, European regulatory requirements include requirements of minimum occupied channel bandwidth and maximum power spectral density. Regarding the requirement of OCB, when a terminal transmits data by using a channel, the occupied channel bandwidth is required to be not less than 80% of a total channel bandwidth. In order to meet the occupancy requirement of OCB, for SL-U, an interlaced resource block (IRB) structure in NR-U may be introduced.

One interlace resource includes N PRBs that are discrete in frequency domain, a total of M interlace resources are included in a band range, and PRBs included in the m^{th} interlace are {m, M+m, 2M+m, 3M+m, . . . }.

As shown in FIG. 14, a system bandwidth includes 20 PRBs (one PRB corresponds to 12 subcarriers), including 5 interlaces (that is, M=5), each interlace includes 4 PRBs (that is, N=4), and adjacent PRBs in one interlace are spaced by the same frequency domain interval, that is, 5 PRBs. The numbers in boxes in the figure represent interlace indexes. It should be noted that, PRBs included in an interlace may also be referred to as IRBs, and the interlace may also be referred to as IRBs.

In addition to the IRB structure, a concept of resource block set (RB set) may also be introduced in SL-U.

In some implementations, frequency domain resources on a carrier may be divided into several resource block sets, and a guard band may be configured between the resource block sets. For example, one RB set corresponds to a frequency domain width of 20 MHz. A communications device is required to perform listen before talk (LBT) on the unlicensed spectrum, and data is transmitted only after LBT succeeds. Generally, a granularity for performing LBT may be one RB set, and thus one RB set may also be referred to as an LBT sub-band. That is, if the communications device transmits data on a specific RB set, LBT is required to be performed on the corresponding RB set, and transmission is performed after LBT succeeds.

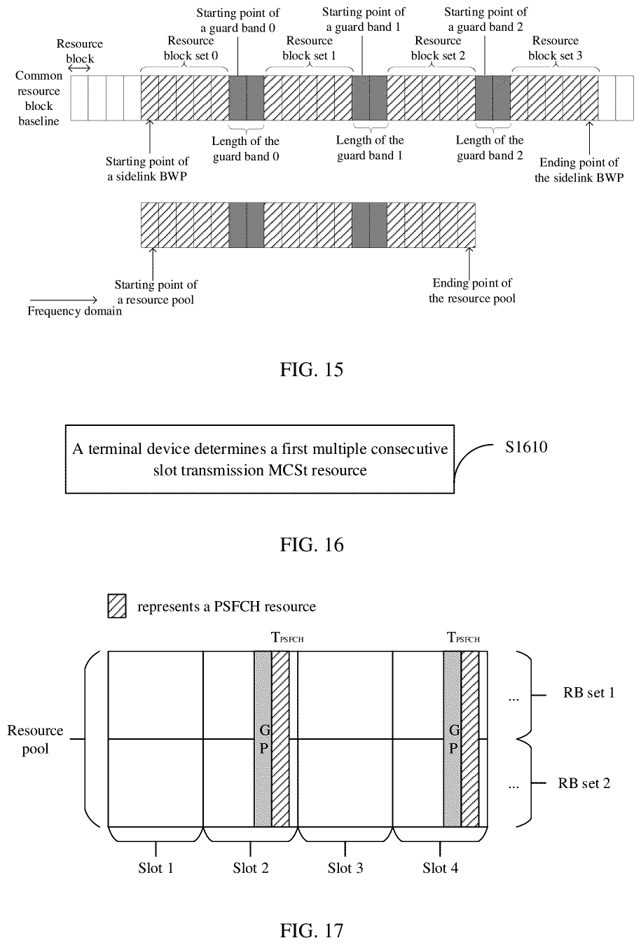

One RB set includes a plurality of IRBs. For simplicity, in FIG. 15, one resource block actually corresponds to one IRB in FIG. 14. Generally, a BWP configured for a communications device includes an integer quantity of RB sets.

FIG. 15 is an example of a resource pool configured on an unlicensed spectrum to which an embodiment of this application is applicable. In an SL-U system, a resource pool may be configured on an unlicensed spectrum or a shared spectrum by using pre-configuration information or network configuration information to perform sidelink transmission.

In some implementations, the resource pool includes M1 resource block sets (RB set), and one resource block set may include M2 resource blocks (RB), where M1 and M2 are positive integers.

In some implementations, an RB set may correspond to a channel in an unlicensed spectrum (or a shared spectrum). For example, an RB set may be a channel in an unlicensed spectrum (or a shared spectrum). Therefore, an RB set may also be referred to as a “channel”.

Assuming that a bandwidth corresponding to a channel on the unlicensed spectrum is 20 MHz, a bandwidth corresponding to the RB set may accordingly be 20 MHz.

It is assumed that a bandwidth of a channel on the unlicensed spectrum is 20 MHz, corresponding to M3 RBs, where M3 RBs are all RBs included in one channel, or all RBs that usable for data transmission in a channel. If M3=100 (corresponding to a subcarrier spacing of 15 kHz), the RB set may accordingly include 100 RBs, that is, M2=100.

In some other implementations, one RB set may correspond to a minimum frequency domain granularity for performing LBT; in other words, one RB set may correspond to an LBT sub-band. For example, one RB set may be one LBT sub-band, and therefore, the RB set may also be referred to as an LBT sub-band.

Assuming that the minimum frequency domain granularity for performing LBT on the unlicensed spectrum is 20 MHz, one RB set may include a quantity of RBs corresponding to 20 MHz.

Assuming that one RB set includes 100 RBs (corresponding to a subcarrier spacing of 15 kHz), that is, M2=100 RBs, then correspondingly the minimum frequency domain granularity of LBT is one RB set, namely, 100 RBs.

In some implementations, a frequency domain start position of the resource pool may be determined based on a frequency domain start position of a first RB set in the M1 RB sets. For example, the frequency domain start position of the resource pool may be the same as the frequency domain start position of the first RB set. The first RB set is an RB set with the lowest frequency domain position in the M1 RB sets (or the first RB set).

In some implementations, a frequency domain end position of the resource pool may be determined based on a frequency domain end position of a second RB set in the M1 RB sets. For example, the frequency domain end position of the resource pool may be the same as the frequency domain end position of the second RB set. The second RB set is an RB set with the highest frequency domain position in the M1 RB sets (or the last RB set).

For example, the resource pool includes three RB sets (that is, M1=3), and indexes corresponding to the RB sets are RB set 0, RB set 1, and RB set 2, respectively. The RB set 0 has the lowest frequency domain position, and the RB set 2 has the highest frequency domain position. Therefore, the frequency domain start position of the resource pool may be the same as the frequency domain start position of the RB set 0, and the frequency domain end position of the resource pool can be the same as the frequency domain end position of the RB set 2.

In some scenarios, a guard band (GB), also referred to as a “guard frequency band”, may be provided between two adjacent RB sets in the M1 RB sets included in the resource pool, where the guard band may be used to separate the RB sets.

In some implementations, a frequency domain start position and a frequency domain size of the guard band may be determined based on pre-configuration information or network configuration information. Correspondingly, a terminal may acquire pre-configuration information or network configuration information, where the pre-configuration information or the network configuration information is used to configure a guard band.

For ease of understanding, the following describes a configuration manner of the resource pool on the unlicensed spectrum to which an embodiment of this application is applicable with reference to FIG. 15. Referring to FIG. 15, three guard bands are configured in a sidelink bandwidth part (BWP), namely a guard band 0, a guard band 1, and a guard band 2. The three guard bands separate four RB sets. A frequency domain start position and a frequency domain end position of each RB set may be determined based on a frequency domain start position of each guard band (i.e., a starting point of a guard band shown in the figure) and a frequency domain size of the guard band (i.e., a length of a guard band shown in the figure).

Accordingly, the four RB sets may be included in the sidelink BWP, and a resource pool is configured in the sidelink BWP (hereinafter referred to as “resource pool”). The resource pool may include three RB sets, namely, RB set 0 to RB set 2. Therefore, a frequency domain start position of the resource pool (i.e., the starting point of the resource pool shown in FIG. 15) may be the same as a frequency domain start position of the RB set 0, and a frequency domain end position of the resource pool (i.e., the ending point of the resource pool shown in FIG. 15) may be the same as a frequency domain end position of the RB set 2.

In some scenarios, one RB set includes one or more sub-channels. For example, each RB set in FIG. 15 may include one or more sub-channels.

In some implementations, one PSCCH may be transmitted in one or more RB sets. In some other implementations, one PSSCH may be transmitted in one or more RB sets, and the PSSCH occupies one or more sub-channels in the one or more RB sets.

In embodiments of this application, an RB may include 12 consecutive subcarriers in one slot, and a PRB may include 12 consecutive subcarriers in one OFDM symbol. It should be noted that, for ease of understanding, the following description is provided by using an RB as an example. In embodiments of this application, the RB may be interchangeable with a PRB, that is, in following solutions involving an RB, the RB may be replaced with a PRB.

In addition, the solutions of embodiments of this application may also be applied to an interleaved resource block, also referred to as “interleaved physical resource blocks (interlaced PRB, IRB)”, that is, in following solution involving an RB, the RB may also be replaced with an interleaved resource block. It should be understood that, since abbreviations of the interleaved PRB and interlaced resource block may both be “IRB”, in order to facilitate distinction, in embodiments of this application, “IRB” may refer to interlaced resource block, and interleaved resource block is expressed as “interleaved PRB”.

### Multiple Consecutive Slot Transmission (MCSt)

As mentioned above, in an unlicensed spectrum, a communications device is required to perform LBT first, and then may access a channel after LBT succeeds. When the communications device successfully accesses the channel through LBT, the communications device may transmit continuously or discontinuously in a corresponding COT. On the one hand, in order to fully use the COT initiated after the LBT succeeds, a concept of MCSt transmission may be introduced in SL-U, that is, the communications device may transmit continuously in a plurality of slots to improve utilization of the COT. On the other hand, use of MCSt transmission may cause the channel to be continuously used/occupied, which is beneficial for competing for the channel with another system (for example, a Wi-Fi system) and avoids access to the channel by the another system through LBT. For example, when the SL-U terminal uses MCSt transmission, since the channel can be continuously occupied in the COT, in this case, a Wi-Fi user cannot access the channel through LBT.

It should be noted that, in embodiments of this application, MCSt may be understood as a consecutive transmission performed by occupying all time domain resources in a plurality of slots. Certainly, MCSt may alternatively be understood as a consecutive transmission performed by occupying part of time domain resources, i.e., one or some slots in a plurality of slots. In this case, there may be a time interval between the time domain resources occupied by the MCSt. However, since the MCSt occupies each of the plurality of slots, it may still be considered as consecutive transmission.

As mentioned above, based on advantages of MCSt, it is discussed currently that the MCSt mode is about to be introduced into an SL-U system. However, how the SL-U system supports MCSt transmission is still an urgent problem to be solved.

Therefore, according to embodiment of this application, a method for sidelink communication is provided to specify an MCSt resource (hereinafter referred to as “a first MCSt resource”) occupied by MCSt in an SL-U system, which facilitates implementation of MCSt in the SL-U system. A method for sidelink communication according to an embodiment of this application is described below with reference to FIG. 16.

FIG. 16 is a schematic flowchart of a method for sidelink communication according to an embodiment of this application. The method shown in FIG. 16 includes step S1610.

In step S1610, a terminal device determines a first multiple consecutive slot transmission MCSt resource.

In time domain, the first MCSt resource may occupy M consecutive slots, where M is a positive integer greater than 1.

It should be noted that, the first MCSt resource occupying M consecutive slots may be understood as that the first MCSt resource occupies all time domain resources in the M slots for consecutive transmission. Certainly, in embodiments of this application, the first MCSt resource may alternatively occupy part of the time domain resources in the M slots for consecutive transmission. In this case, there may be a time interval between the time domain resources occupied by the first MCSt resource. However, since the first MCSt resource occupies each of a plurality of slots, it may still be considered as consecutive transmission.

In addition, in some implementations, the time interval may be shorter than the shortest time required for another system to preempt resources. In this way, the another system may be prevented from preempting transmission resources. The time interval may be, for example, less than or equal to 16 microseconds.

In frequency domain, the first MCSt resource may be mapped in a sidelink resource pool (hereinafter referred to as “resource pool”) with any frequency domain resource granularity, where the frequency domain resource granularity may include an RB, an IRB, a sub-channel, and an RB set. In other words, the first MCSt resource meets one of the following in frequency domain: the first MCSt resource occupying one or more resource blocks or interleaved PRBs in a resource pool; the first MCSt resource occupying one or more resource block sets in a resource pool; or the first MCSt resource occupying one or more sub-channels in a resource pool.

If the first MCSt resource occupies one or more resource blocks or interleaved PRBs in the resource pool in frequency domain, in some implementations, RBs (or interleaved PRBs) occupied by the first MCSt resource in different time domain units (for example, different slots or symbols) may be the same or different in quantity. In some other implementations, the RBs (or interleaved PRBs) occupied by the first MCSt resource in different time domain units may be the same or different in position.

In embodiments of this application, the first MCSt resource is mapped with a granularity of resource blocks or interleaved PRBs, which is beneficial to improving flexibility of mapping. In some scenarios, when corresponding frequency domain resources in an available COT (for example, a COT shared by another terminal device or a network device) of a terminal device may be insufficient for forming an RB set, the first MCSt resource may be mapped with a granularity of a resource block or an interleaved PRB, which is beneficial to allowing the first MCSt resource to be in the COT of the terminal device.

If the first MCSt resource occupies one or more RB sets in a resource pool in frequency domain, in some implementations, RB sets occupied by the first MCSt resource in different time domain units (for example, different slots or symbols) may be the same or different in quantity. In some other implementations, the RB sets occupied by the first MCSt resource in different time domain units (for example, different slots or symbols) may be the same or different in position.

As mentioned above, the terminal devices usually perform LBT in a granularity of RB set. If resources for performing LBT by the terminal device are less than one RB set, an LBT failure usually occurs. Therefore, when the first MCSt resource is mapped in a granularity of RB or sub-channel, another terminal device may still initiate LBT on another resource in the RB set occupied by the first MCSt resource. However, the LBT may fail because part of frequency domain resources in the RB set are occupied by the first MCSt resource. If the first MCSt resource is mapped in a granularity of RB set, another terminal device will not initiate LBT in the RB set because resources in the RB set are fully occupied by the first MCSt resource. Therefore, mapping the first MCSt resource in a granularity of RB set is beneficial to avoiding invalid LBT initiated by another terminal device.

If the first MCSt resource occupies one or more sub-channels in a resource pool in frequency domain, in some implementations, sub-channels occupied by the first MCSt resource in different time domain units (for example, different slots or symbols) may be the same or different in quantity. In some other implementations, sub-channels occupied by the first MCSt resource in different time domain units (for example, different slots or symbols) may be the same or different in position.

Still referring to FIG. 9 or FIG. 10, in an NR-U system, the last symbol of each slot may be used for switching between reception and transmission. In the SL-U system, the last symbol of each slot may alternatively be used for the terminal device to perform LBT channel listening. Therefore, in some implementations, in order to reserve resources for the terminal device (the terminal device or another terminal device) to perform LBT channel listening, the first MCSt resource may not occupy the last symbol of one or more slots in M slots in time domain. Certainly, in embodiments of this application, the first MCSt resource may occupy the last symbol of one or more slots in the M slots in time domain.

In order to ensure that the terminal device can perform MCSt, the first MCSt resource may occupy the last symbols in the 1st slot to the (M−1)^{th} slot in the M slots in time domain, while does not occupy the last symbol in the M^{th} slot, so that the symbol may be used for LBT channel listening.

In embodiments of this application, the first MCSt resource may occupy the last symbols of the 1st slot to the (M−1)^{th} slot, which is beneficial to providing appropriate resources for the terminal device to perform MCSt. In addition, in embodiments of this application, the last symbol in the M^{th} slot may be reserved for LBT channel listening of the terminal device to improve properness of the time domain resources occupied by the first MCSt resource.

In some implementations, it may be determined, based on frequency domain resources occupied by the first MCSt resource in the last symbol, that whether the first MCSt resource occupies or does not occupy the last symbol. In other words, whether the first MCSt resource occupies or does not occupy the last symbol is determined based on the frequency domain resources occupied by the first MCSt resource in the last symbol.

For example, whether the first MCSt resource occupies or does not occupy the last symbol may be determined based on a size of the frequency domain resources occupied by the first MCSt resource in the last symbol.

As described above, in the SL-U system, the terminal device usually performs LBT with an RB set as a frequency domain granularity. Therefore, if frequency domain resources reserved for LBT in the last symbol are less than an RB set, the terminal device usually cannot perform LBT successfully. In this case, LBT channel listening on the last symbol may be not performed. Accordingly, in order to improve resource utilization, the first MCSt resource may occupy the last symbol. In other words, if the frequency domain resource occupied by the first MCSt resource on the last symbol is a resource block set, the first MCSt resource occupies the last symbol.

On the contrary, if the frequency domain resources reserved for LBT on the last symbol are greater than or equal to an RB set, the terminal device may perform LBT channel listening on the RB set of the symbol. In this case, the first MCSt resource may not occupy the last symbol, or the first MCSt resource occupies part of time domain resources in the last symbol. Correspondingly, if the first MCSt resource occupies part of the time domain resources in the last symbol, time not occupied by the first MCSt resource in the last symbol may be used for LBT. In other words, if the frequency domain resources occupied by the first MCSt resource in the last symbol are part of frequency domain resources in the resource block set, the first MCSt resource does not occupy the last symbol, or the first MCSt resource occupies part of the time domain resources in the last symbol.

For example, assuming that LBT requires 16 microseconds and the first MCSt resource occupies part of the time domain resources in the last symbol, in order to reserve resources required for LBT, a time length corresponding to resources not occupied by the first MCSt in the last symbol may be 16 microseconds.

Still referring to FIG. 10, in some scenarios, one slot may further include a PSFCH resource. Therefore, a relationship between the first MCSt resource and the PSFCH resource is also discussed in embodiments of this application.

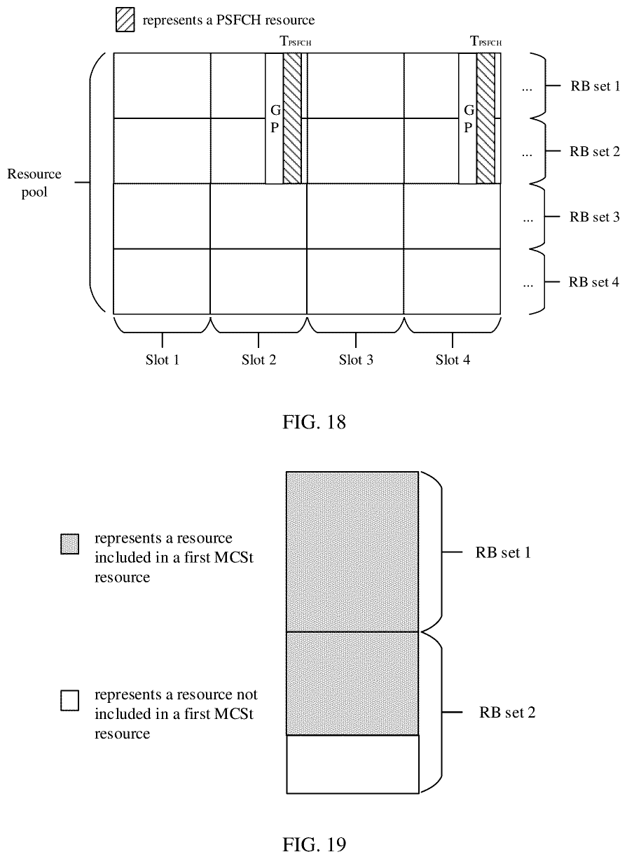

For ease of understanding, the following first introduces two PSFCH resource configuration manners provided in embodiments of this application with reference to FIG. 17 and FIG. 18. Then the relationship between the first MCSt resource and the PSFCH resource in embodiments of this application is introduced with reference to FIGS. 17 and 18.

In a PSFCH resource configuration mode 1, a PSFCH resource exists in all RB sets included in a resource pool, or in other words, the PSFCH resource occupies all RB sets in the resource pool in frequency domain.

As shown in FIG. 17, assuming that the resource pool includes slots 1 to 4 in time domain, and includes RB set 1 and RB set 2 in frequency domain. A time domain where the PSFCH resource is located is symbols T_{PSFCH} in slot 2 and slot 4, and it may be learned based on the PSFCH resource configuration mode 1 that, resources in time domain where the PSFCH resource is located are resources in the symbols T_{PSFCH} where the PSFCH resource is located, that is, the resources in time domain where the PSFCH resource is located include the symbols T_{PSFCH} in time domain and the RB set 1 and the RB set 2 in frequency domain. In this case, all resources in resources in time domain where the PSFCH resource is located are used to transmit a PSFCH.

In addition, based on the PSFCH resource configuration mode 1, it may be learned that the resources in frequency domain where the PSFCH resource is located are the RB set 1 and the RB set 2 in the resource pool, namely, all RB sets in the resource pool.

In a PSFCH resource configuration mode 2, a PSFCH resource exists in part of RB sets included in a resource pool, or in other words, the PSFCH resource occupies part of RB sets in the resource pool in frequency domain.

As shown in FIG. 18, it is assumed that a resource pool includes slot 1 to slot 4 in time domain and RB set 1 to RB set 4 in frequency domain. A PSFCH resource occupies the symbols T_{PSFCH} in the slot 2 and the slot 4, and the PSFCH resource in the frequency domain is located in the RB set 1 and the RB set 2, that is, there is no frequency domain resource for transmitting a PSFCH in the RB set 3 and the RB set 4. Based on the PSFCH resource configuration mode 2, it may be learned that resources in time domain where the PSFCH resource is located are resources in the symbols T_{PSFCH} where the PSFCH resource is located, that is, the resources in time domain where the PSFCH resource is located include the symbols T_{PSFCH} in time domain and the RB set 1 to RB set 4 in frequency domain. In this case, part of the resources in time domain where the PSFCH resource is located are used to transmit a PSFCH.

In addition, based on the PSFCH resource configuration mode 2, it may be learned that the resources in frequency domain where the PSFCH resource is located are the RB set 1 and the RB set 2 in the resource pool, i.e., part of the RB sets in the resource pool.

The following describes the relationship between the first MCSt resource and the PSFCH resource. In some implementations, the first MCSt resource may meet one or more of the following: including a resource in time domain where a PSFCH resource is located; including a resource in frequency domain where a PSFCH resource is located; including a PSFCH resource; including no resource in time domain where a PSFCH resource is located; including no resource in frequency domain where a PSFCH resource is located; or including no PSFCH resource.

The following introduces, with reference to FIG. 17 and FIG. 18, a relationship between the first MCSt resource and the PSFCH resource obtained when the first MCSt resource is mapped in a granularity of RB set, and a relationship between the first MCSt resource and the PSFCH resource obtained when the first MCSt resource is mapped in a granularity of RB (or interleaved PRB).

The first MCSt resource including no resource in time domain where a PSFCH resource is located is used as an example. As shown in FIG. 17, the first MCSt resource includes neither of the symbols T_{PSFCH} in time domain, and includes neither of the RB set 1 and RB set 2 in frequency domain. As shown in FIG. 18, the first MCSt resource includes neither of the symbols T_{PSFCH} in time domain, and includes none of the RB set 1 to the RB set 4 in frequency domain.

The first MCSt resource including a resource in time domain where a PSFCH resource is located is used as an example. As shown in FIG. 17, the first MCSt resource includes the symbols T_{PSFCH} in time domain, and includes the RB set 1 and the RB set 2 in frequency domain. As shown in FIG. 18, the first MCSt resource includes the symbols T_{PSFCH} in time domain, and includes the RB set 1 to the RB set 4 in frequency domain.

The first MCSt resource including no resource in frequency domain where a PSFCH resource is located is used as an example. As shown in FIG. 17, the first MCSt resource may include none of resources in the RB set 1 and the RB set 2. As shown in FIG. 18, the first MCSt resource may include none of resources in the RB set 1 and the RB set 2, and accordingly, the first MCSt resource may include the RB set 3 and the RB set 4.

The first MCSt resource including a resource in frequency domain where a PSFCH resource is located is used as an example. As shown in FIG. 17, the first MCSt resource may include resources in the RB set 1 and the RB set 2. As shown in FIG. 18, the first MCSt resource may include resources in the RB set 1 to the RB set 4.

The first MCSt resource including a PSFCH resource is used as an example. As shown in FIG. 17, the first MCSt resource includes the RB set 1 and the RB set 2 in the resource symbols T_{PSFCH}. As shown in FIG. 18, the first MCSt resource includes the RB set 1 and the RB set 2 in the resource symbols T_{PSFCH}.

The first MCSt resource including no PSFCH resource is used as an example. As shown in FIG. 17, the first MCSt resource include neither the RB set 1 nor the RB set 2 in any resource symbol T_{PSFCH}. As shown in FIG. 18, the first MCSt resource includes neither the RB set 1 nor the RB set 2 in any resource symbol T_{PSFCH}.

Still referring to FIG. 10, if a slot includes the PSFCH resource, accordingly, the slot will also be provided with an AGC symbol for reception of a PSFCH and a symbol GP for switching between reception and transmission of a PSFCH. In some implementations, if the first MCSt resource includes a resource in time domain where the PSFCH resource is located, it may be unnecessary to receive a PSFCH in the PSFCH resource, and then the GP symbol and the AGC symbol are also unnecessary. Therefore, in order to improve resource utilization, the GP symbol and/or the AGC symbol can alternatively be used for MCSt, that is, the first MCSt resource further includes the AGC symbol for reception of a PSFCH, and/or, a symbol occupied by a GP and located before the AGC symbol in time domain.

In some implementations, whether the first MCSt resource includes a resource in time domain where the PSFCH resource is located is determined based on a first condition, where the first condition may be determined based on one or more of the following: whether the first MCSt resource includes a resource in frequency domain where the PSFCH resource is located; or whether there is feedback information for the PSFCH resource.

The first condition including whether the first MCSt resource includes a resource in frequency domain where the PSFCH resource is located is used as an example. In some implementations, if the first MCSt resource does not include a resource in frequency domain where the PSFCH resource is located, the first MCSt resource includes a resource in time domain where the PSFCH resource is located.

For ease of understanding, the following description is provided by using the PSFCH configuration mode shown in FIG. 18 as an example. It is assumed that the first MCSt resource occupies the RB set 3 and the RB set 4 in frequency domain. In this case, the first MCSt resource does not include the resource in frequency domain where the PSFCH resource is located, and correspondingly, the first MCSt resource may include the resource in time domain where the PSFCH resource is located, namely, a resource in a symbol T_{PSFCH}.

In some other implementations, if the first MCSt resource include the resource in frequency domain where the PSFCH resource is located, the first MCSt resource does not include the resource in time domain where the PSFCH resource is located.

For ease of understanding, the following description is still provided by using the PSFCH configuration mode shown in FIG. 18 as an example. It is assumed that the first MCSt resource occupies the RB set 1 and the RB set 2 in frequency domain. In this case, the first MCSt resource includes the resource in frequency domain where the PSFCH resource is located, and correspondingly, the first MCSt resource may not include the resource in time domain where the PSFCH resource is located, namely, a resource in a symbol T_{PSFCH}.

The first condition including whether feedback information exists on the PSFCH resource is used as an example. In some implementations, if no feedback information exists on the PSFCH resource, the first MCSt resource may include the resource in time domain where the PSFCH resource is located. In some other implementations, if feedback information exists on the PSFCH resource, the first MCSt resource does not include the resource in time domain where the PSFCH resource is located.

It should be noted that, the foregoing describes separate uses of the two first conditions for determining whether the first MCSt resource includes the resource in time domain where the PSFCH resource is located. In embodiments of this application, the foregoing two first conditions may alternatively be used in combination to determine whether the first MCSt resource includes the resource in time domain where the PSFCH resource is located. The determination method is similar to that when the two first conditions are used separately. For brevity, details are not described below.

In addition, in embodiments of this application, the first condition may further be used to determine whether the first MCSt resource includes a PSFCH resource. A specific determination method is similar to that described above. For brevity, details are not described below.

As mentioned above, in a sidelink communication scenario, a PSFCH may be transmitted periodically. In some implementations, M may be less than or equal to a configuration period of the PSFCH, which is beneficial to avoiding collision of the first MCSt resource with the PSFCH. Still referring to FIG. 17, it is assumed that a configuration period of a PSFCH is 2 slots, that is, there is a symbol including a PSFCH resource in every 2 slots. Therefore, there is a symbol including a PSFCH resource in each of slot 2 and slot 4. In this case, M is at most 2. Certainly, in embodiments of this application, M may alternatively be greater than the configuration period of the PSFCH.

In some implementations, if MCSt has a high requirement for continuity, that is, no PSFCH resource is included in the M slots occupied by the first MCSt resource, then M may be configured to be less than or equal to the configuration period of the PSFCH; otherwise, the PSFCH cannot be transmitted in the M slots. Certainly, if the problem of transmission of the PSFCH is not considered, in this scenario, M may alternatively be configured to be greater than the configuration period of the PSFCH.

In some other implementations, if MCSt has a low requirement for continuity, that is, a PSFCH resource is included in the M slots occupied by the first MCSt resource, then M may be configured to be greater than the configuration period of the PSFCH. Certainly, in this scenario, M may alternatively be configured to be less than or equal to the configuration period of the PSFCH.

In some implementations, the configuration of M may alternatively be associated with a frequency domain resource occupied by the first MCSt resource. For example, if the first MCSt resource occupies one or more resource block sets in a resource pool in frequency domain, M is less than or equal to a configuration period of a PSFCH resource. For another example, if the first MCSt resource occupies one or more resource blocks or interleaved PRBs in the resource pool in frequency domain, M is greater than the configuration period of the PSFCH resource.

For ease of understanding, a first MCSt resource in embodiments of this application is introduced below in combination with Embodiment 1 and Embodiment 2. In Embodiment 1, the first MCSt resource is one or more RB sets in M slots that are consecutive in time domain. In Embodiment 2, the first MCSt resource is one or more RBs in M slots that are consecutive in time domain.

### Embodiment 1

It is assumed that the first MCSt resource occupies M consecutive slots and occupies all resources of the last symbols in the 1st slot to the (M−1)^{th} slot. In other words, the last symbol of the M^{th} slot may be used for LBT channel monitoring.

If a PSFCH resource is configured in a resource pool, a configuration period of the PSFCH resource is 2. If a value of M is configured to be not greater than the configuration period of the PSFCH resource, the value of M may be 2. In this case, for a relationship between the first MCSt resource and the PSFCH resource, reference may be made to the four implementations described below.

In implementation 1, a resource in a symbol where the PSFCH resource is located is not included in the M consecutive slots.

Still referring to FIG. 17, the first MCSt resource does not include an RB set in symbols T_{PSFCH} in slot 2 and slot 4, namely, RB set 1 and RB set 2 in the symbols T_{PSFCH}.

In implementation 2, the PSFCH resource is not included in the first MCSt resource.

In some implementations, if the first MCSt resource includes an RB set of the PSFCH resource in frequency domain, the first MCSt resource does not include a symbol of the PSFCH resource. Referring to FIG. 18, if the first MCSt resource includes RB set 1 or RB set 2, the first MCSt resource does not include RB set 1 or RB set 2 in the symbols T_{PSFCH} where the PSFCH resource is located.

In some implementations, if the first MCSt resource does not include an RB set where the PSFCH resource is located in frequency domain, the first MCSt resource may include the symbol T_{PSFCH} where the PSFCH resource is located. Referring to FIG. 18, if the first MCSt resource includes RB set 3 and RB set 4, but includes neither of RB set 1 and RB set 2, the first MCSt resource may include the symbol T_{PSFCH} where the PSFCH resource is located. In this case, the first MCSt resource may further include an AGC symbol for reception of a PSFCH and a GP symbol located before the AGC symbol.

If the first MCSt resource may include the symbol T_{PSFCH} where the PSFCH resource is located, it means that a PSFCH is not required to be transmitted to indicate whether corresponding data is correctly received. In this case, in order to improve reliability of data transmission, different retransmissions of the same data (for example, TB) may be performed in the first MCSt resource. Certainly, in the foregoing case, different data may alternatively be transmitted in the first MCSt resource.

In some implementations, if the first MCSt resource includes both the RB set where the PSFCH resource is located and an RB set where the PSFCH resource is not located in frequency domain, then in the RB set where the PSFCH resource is located, the first MCSt resource may not include the symbol T_{PSFCH} where the PSFCH resource is located; in the RB set where the PSFCH resource is not included, the first MCSt resource may include the symbol T_{PSFCH} where the PSFCH resource is located.

Still referring to FIG. 18, RB set 1 and RB set 2 are RB sets including the PSFCH resource. In RB set 1 and RB set 2, the first MCSt resource may not include the symbol T_{PSFCH} where the PSFCH resource is located. RB set 3 and RB set 4 are RB sets not including the PSFCH resource. In RB set 3 and RB set 4, the first MCSt resource may include the symbol T_{PSFCH} where the PSFCH resource is located.

In implementation 3, the PSFCH resource is included in the first MCSt resource.

If the PSFCH resource presents in a slot from the 1st slot to the (M−1)^{th} slot, the first MCSt resource may further include an AGC symbol for reception of the PSFCH and a GP located before the AGC symbol.

In some implementations, in order to ensure a minimum occupied channel bandwidth, a plurality of common RBs are specified in a specific symbol, and a bandwidth of the plurality of common RBs (for example, common interleaved RBs or common RBs) meets the minimum occupied channel bandwidth. Accordingly, on the symbol T_{PSFCH} originally used to transmit a PSFCH, the terminal device may occupy a plurality of common RBs in the symbol T_{PSFCH}.

That the first MCSt resource includes the PSFCH resource means that the PSFCH is not required to be transmitted to indicate whether corresponding data is correctly received. In this case, in order to improve reliability of data transmission, different retransmissions of the same data (for example, TB) may be performed in the first MCSt resource. Certainly, in the foregoing case, different data may alternatively be transmitted in the first MCSt resource.

In implementation 4, an RB set where the PSFCH resource is located may be included in the first MCSt resource.

If the PSFCH resource presents in a slot from the 1st slot to the (M−1)^{th} slot, in some implementations, if a target receiving terminal of the terminal device does not feedback HARQ information to the terminal device on the PSFCH resource, the first MCSt resource may include an AGC symbol for reception of the PSFCH and a GP located before the AGC symbol.

In some implementations, on the symbol T_{PSFCH} originally used to transmit a PSFCH, the terminal device may occupy a common RB in the symbol T_{PSFCH}.

If the PSFCH resource presents in a slot from the 1st slot to the (M−1)^{th} slot, in some other implementations, if the target receiving terminal feeds back HARQ information to the terminal device on the PSFCH resource, the first MCSt resource includes neither the PSFCH resource nor the AGC symbol for reception of the PSFCH.

### Embodiment 2

It is assumed that the first MCSt resource occupies M consecutive slots, accordingly, whether the first MCSt resource occupies the last symbols of the 1st slot to the (M−1)^{th} slot may be discussed for the following two cases: case 1 and case 2.

In case 1, assuming that the first MCSt resource occupies an RB set on the last symbols in the 1st slot to the (M−1)^{th} slot, the first MCSt resource may include the last symbol in each of the foregoing slots.

As shown in FIG. 19, all resources in RB set 1 belong to the first MCSt resource, and part of resources in RB set 2 belong to the first MCSt resource. If RB sets on the last symbols of the 1 st slot to the (M−1)^{th} slot are all like RB set 1, the first MCSt resource may occupy the last symbols of the 1st slot to the (M−1)^{th} slot.

In case 2, assuming that the first MCSt resource occupies part of resources in the RB set on the last symbol in the 1st slot to the (M−1)^{th} slot, the first MCSt resource may include part of resources in the last symbol in each of the foregoing slots, or the first MCSt resource may not include the last symbol in each of the foregoing slots.

As shown in FIG. 19, if the RB sets on the last symbols of the 1st slot to the (M−1)^{th} slot are all like RB set 2, the first MCSt resource may occupy part of resources in the last symbols of the 1st slot to the (M−1)^{th} slot.

As shown in FIG. 19, if the RB sets on the last symbols of the 1st slot to the (M−1)^{th} slot are all like RB set 2, the first MCSt resource may not occupy the last symbols of the 1st slot to the (M−1)^{th} slot.

If the PSFCH resource is configured in a resource pool, a configuration period of the PSFCH resource is 2, and a value of M may be configured to be greater than the configuration period of the PSFCH resource. In this case, for a relationship between the first MCSt resource and the PSFCH resource, reference may be made to the four implementations described below.

It should be noted that, the value of M may be greater than the configuration period of the PSFCH resource, which may be understood as that the PSFCH resource may present in one or some slots in the first MCSt resource. In this case, the first MCSt resource includes neither an AGC symbol for reception of a PSFCH nor a GP symbol before the AGC symbol.

In implementation 1, a resource in a symbol where the PSFCH resource is located is not included in the first MCSt resource.

Still referring to FIG. 17, the first MCSt resource does not include any RB set in symbols T_{PSFCH} in slot 2 and slot 4, i.e., none of RB set 1 and RB set 2 in the symbols T_{PSFCH}.

In implementation 2, the PSFCH resource is not included in the first MCSt resource.

In some implementations, if the first MCSt resource includes an RB set of the PSFCH resource in frequency domain, the first MCSt resource does not include a symbol of the PSFCH resource. Referring to FIG. 18, if the first MCSt resource includes RB set 1 or RB set 2, the first MCSt resource does not include the symbol T_{PSFCH} where the PSFCH resource is located.

In some other implementations, if the first MCSt resource does not include an RB set of the PSFCH resource in frequency domain, the first MCSt resource includes the symbol of the PSFCH resource. Referring to FIG. 18, if the first MCSt resource includes RB set 3 or RB set 4, the first MCSt resource may include the symbol T_{PSFCH} where the PSFCH resource is located.

In implementation 3, the PSFCH resource is included in the first MCSt resource.

Still referring to FIG. 18, the PSFCH resource is RB set 1 and RB set 2 in the symbols T_{PSFCH}.

In some implementations, that the first MCSt resource includes the PSFCH resource means that a PSFCH is not required to be transmitted to indicate whether corresponding data is correctly received. In this case, in order to improve reliability of data transmission, different retransmissions of the same data (for example, TB) may be performed in the first MCSt resource. Certainly, in the foregoing case, different data may alternatively be transmitted in the first MCSt resource.

In some implementations, if the PSFCH resource presents in a slot from the 1st slot to the (M−1)^{th} slot in the first MCSt resource, the first MCSt resource may include a PSFCH symbol and an AGC symbol for reception of the PSFCH. A relationship between the first MCSt resource and an RB set on the PSFCH symbol may include the following two cases.

In case 1, if the PSFCH resource presents in the RB set on the PSFCH symbol, the first MCSt resource includes a common RB (for example, a common PRB or a common interleaved PRB) in the PSFCH symbol, so as to ensure a minimum occupied channel bandwidth.

It should be noted that, on the AGC symbol used for reception of the PSFCH, the terminal device may copy a signal transmitted in the PSFCH symbol.

In case 2, if there is no PSFCH resource in the RB set on the PSFCH symbol, the first MCSt resource may include an RB set in all PSFCH symbols, in the AGC symbol used for reception of the PSFCH, and in the GP symbol before the AGC symbol.

It should be noted that, the solution in which the first MCSt resource is mapped in a granularity of RB introduced above is also applicable to a case in which the first MCSt resource is mapped in a granularity of sub-channel, and the sub-channel may include one or more RBs that are consecutive in frequency domain. Accordingly, the RB in Embodiment 2 may be replaced with a sub-channel, and for brevity, details are not described below.

It should also be noted that, the solution in which the first MCSt resource is mapped in a granularity of RB described above is also applicable to a case in which the first MCSt resource is mapped in a granularity of interleaved PRB. Accordingly, the RB in Embodiment 2 may be replaced with an interleaved PRB, and for brevity, details are not described below.

It may be learned from the foregoing description that conventional resource selection in a sidelink system is performed in a granularity of slot, and the resource selection in the granularity of slot may not match MCSt. Therefore, how to ensure MCSt in a resource selection process of an SL-U system is an urgent problem to be solved.

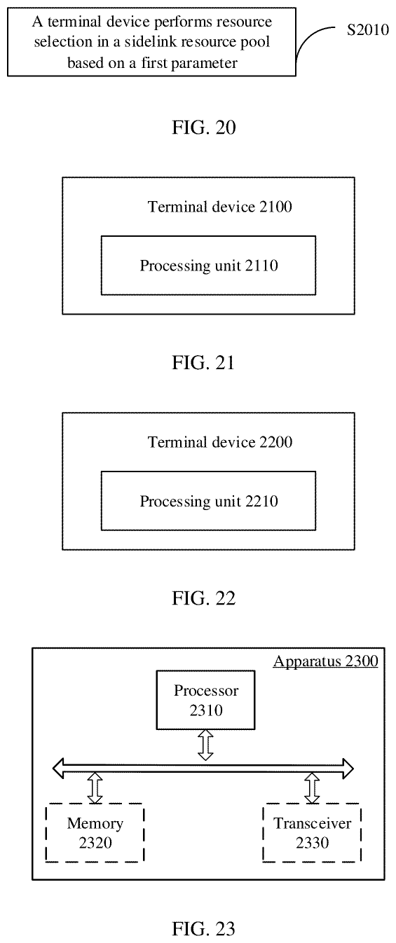

Therefore, an embodiment of this application further provides a method for sidelink communication, in which a terminal device may perform resource selection in a sidelink resource pool based on a first parameter associated with an MCSt resource, so as to ensure MCSt. A method for sidelink communication according to another embodiment of this application is described below with reference to FIG. 20.

FIG. 20 is a schematic diagram of the method for sidelink communication according to another embodiment of this application. The method shown in FIG. 20 includes step S2010.

In step S2010, a terminal device performs resource selection in a sidelink resource pool based on a first parameter.

In some implementations, the first parameter may include a second parameter, and the second parameter may correspond to a time domain resource granularity of an MCSt resource. The time domain resource granularity may be, for example, a slot, or the time domain resource granularity may be, for example, a time domain resource group (or “slot group”), where the time domain resource group may include one or more slots.

In some other implementations, the second parameter may be used for indicating that the MCSt resource occupies M consecutive slots in the sidelink resource pool in time domain, where M is a positive integer greater than 1.

In some implementations, the first parameter includes a third parameter, and the third parameter corresponds to a frequency domain resource granularity of the MCSt resource. The frequency domain resource granularity may include one or more of an RB set, an interleaved PRB, an RB, or a sub-channel.

In some other implementations, the third parameter may be used for indicating that the MCSt resource occupies one or more resource blocks or interleaved PRBs in the sidelink resource pool in frequency domain; or the third parameter is used for indicating that the MCSt resource occupies one or more resource block sets in a resource pool in frequency domain; or the third parameter is used for indicating that the MCSt resource occupies one or more sub-channels in a resource pool in frequency domain.

In some implementations, the second parameter and the third parameter may correspond to a time-frequency domain resource granularity, and the time-frequency domain resource granularity may be used for resource exclusion and/or resource selection in the sidelink resource pool.

For ease of understanding, a resource selection process of an embodiment of this application is described below. It is assumed that the second parameter indicates that the time domain resource granularity of the MCSt resource is M slots, and the third parameter indicates that the frequency domain resource granularity of the MCSt resource is N RBs, where N is a positive integer not less than 1. Accordingly, the time-frequency domain resource granularity formed by the second parameter and the third parameter may be N RBs in M slots.

A MAC layer of the terminal device may indicate the second parameter and the third parameter to a physical layer of the terminal device, and accordingly, the physical layer of the terminal device uses the second parameter and the third parameter as a resource granularity to perform resource exclusion and resource reporting. For example, R(x,y) in the resource selection process based on resource listening described above may be defined as a resource formed by N RBs starting with y in M consecutive slots starting from a slot X, i.e., {M,N}.

Accordingly, after resource exclusion is completed, the physical layer reports a candidate resource set to a MAC layer, and the MAC layer may select an MCSt resource formed by M′ consecutive slots from the candidate resource set, where a value of M′ may be greater than or equal to a value of M corresponding to the candidate resource set.

It should be noted that, if the physical layer performs resource exclusion based on a plurality of resource granularities, one candidate resource set may be obtained for each resource granularity, and accordingly, the MAC layer may select a resource from a plurality of candidate resource sets.

In some other implementations, the first parameter may include a plurality of parameter combinations, and each parameter combination includes a second parameter and a third parameter. The plurality of parameter combinations correspond to a plurality of time-frequency domain resource granularities, and the plurality of time-frequency domain resource granularities are used for resource exclusion and/or resource selection in a sidelink resource pool. Certainly, in embodiments of this application, a time-frequency domain resource granularity (also referred to as “resource granularity”) indicated by one combination of the second parameter and the third parameter may alternatively be used for resource exclusion and/or resource selection in the sidelink resource pool.

It should be noted that, some parameters in the plurality of parameter combinations may be the same. Certainly, in embodiments of this application, parameters included in the plurality of parameter combinations may alternatively be completely different.

For example, assuming that corresponding values of M are M1 and M2, and corresponding values of N are N1 and N2, the plurality of resource granularities may be expressed as {M1, N1}, {M2, N2}, the physical layer may perform resource exclusion with {M1, N1} and {M2, N2} as resource granularities, to obtain a candidate resource set S1 and a candidate resource set S2 respectively, and report the candidate resource set S1 and the candidate resource set S2 to the MAC layer. The candidate resource set S1 corresponds to resource granularity {M1, N1}, and the candidate resource set S2 corresponds to resource granularity {M2, N2}.

Finally, the MAC layer may select an MCSt resource from the candidate resource set S1, and the MCSt resource may include M3 consecutive slots, where M3 may be greater than or equal to M1. Alternatively, the MAC layer may select an MCSt resource from the candidate resource set S2, and the MCSt resource may include M3 consecutive slots, where M3 may be greater than or equal to M2.

It should be noted that, in embodiments of this application, the second parameter and/or the third parameter may be indicated by the physical layer to the MAC layer. Certainly, the second parameter and/or the third parameter may alternatively be determined by the physical layer. In some implementations, the MAC layer may indicate the second parameter to the physical layer, and accordingly, the physical layer may determine the third parameter corresponding to the second parameter based on the second parameter and a correspondence between the second parameter and the third parameter.

The correspondence between the second parameter and the third parameter may be predefined in a protocol or configured by a network device. Certainly, the correspondence may alternatively be preconfigured, which is not limited in embodiments of this application.

In some implementations, a fourth parameter is a total quantity of first-type resources in a resource selection window of a sidelink resource pool, and the first-type resources have a time-frequency domain resource granularity of N resource blocks in M consecutive slots, where M is a positive integer greater than 1, and N is a positive integer greater than or equal to 1.

It should be noted that usage of the fourth parameter may be similar to the parameter “Mtotal” in the resource selection process based on resource listening described above. That is to say, it may be determined through calculation, based on the time-frequency resource granularity of the first-type resources, whether a quantity of remaining resources obtained after specific resources are excluded meets a proportion x %.

In embodiments of this application, the terminal device determines a candidate resource set based on the fourth parameter, which facilitates selection of a proper MCSt resource from the candidate resource set.

In some other implementations, it is assumed that the second parameter indicates that the time domain resource granularity of the MCSt resource is M slots, and the third parameter indicates that the frequency domain resource granularity of the MCSt resource is N RBs. In this case, resource exclusion may be performed with N RBs per slot as the resource granularity, that is, resource exclusion is performed with {1, N} as the resource granularity.

Correspondingly, in the foregoing case, the fourth parameter may be defined as a quantity of resources with a resource granularity of {1, N} in a resource selection window. In this case, the fourth parameter still represents a quantity of resources in a granularity of resources per slot in the resource selection window, and whether a quantity of remaining resources meets the proportion x is determined through calculation in a granularity of resources per slot. Assuming that the remaining resources include R resources with a granularity of {M, N}, the corresponding quantity of resources in a granularity of resources per slot is M*R, where R is a positive integer greater than 1.

In embodiments of this application, resource exclusion being performed with {1, N} as a resource granularity may implement resource exclusion with a single slot as a resource granularity, which facilitates avoiding a case that a resource with too high interference is used as a candidate resource.

It should be noted that, whether resource exclusion is performed with {1, N} or {M, N} as the resource granularity may be determined based on an indication of MAC. Certainly, the resource granularity may alternatively be determined independently by the terminal device.

In some implementations, a total quantity of first-type resources in a first candidate resource set selected from the sidelink resource pool is determined based on a fifth parameter, the fifth parameter is used for indicating a threshold for a ratio of a total quantity of first-type resources in a candidate resource set selected from the sidelink resource pool to the total quantity of first-type resources in a resource selection window for the sidelink resource pool, and the first-type resources have a time-frequency domain resource granularity of N resource blocks in M consecutive slots, where M is a positive integer greater than 1, and N is a positive integer greater than or equal to 1.

It should be noted that the usage of the fifth parameter may be similar to the parameter “x %” in the resource selection process based on resource listening described above. That is to say, the fifth parameter is used to determine whether the total quantity of candidate resources selected at a time-frequency resource granularity of the first-type of resources is sufficient to generate a candidate resource set.

It should be noted that, the RB is mainly used as an example in the foregoing description. In embodiments of this application, the RB may be replaced with an interleaved PRB. That is to say, the solution described above is also applicable to a scenario of an interleaved PRB. For brevity, the example of IRB is not described below.

The method embodiments of this application are described above in detail with reference to FIG. 1 to FIG. 20. Apparatus embodiments of this application are described below in detail with reference to FIG. 20 to FIG. 22. It should be understood that the descriptions of the method embodiments correspond to descriptions of the apparatus embodiments, and therefore, for parts that are not described in detail, reference may be made to the foregoing method embodiments.

FIG. 21 is a schematic diagram of a terminal device according to an embodiment of this application. A terminal device 2100 shown in FIG. 21 includes a processing unit 2110.

The processing unit 2110 is configured to determine a first multiple consecutive slot transmission MCSt resource, where the first MCSt resource occupies M consecutive slots in time domain, M is a positive integer greater than 1, and the first MCSt resource meets one of following in frequency domain: the first MCSt resource occupying one or more resource blocks or interleaved PRBs in a sidelink resource pool; the first MCSt resource occupying one or more resource block sets in a sidelink resource pool; or the first MCSt resource occupying one or more sub-channels in a sidelink resource pool.

In a possible implementation, the first MCSt resource occupies or does not occupy a last symbol of one or more slots in the M slots in time domain.

In a possible implementation, the first MCSt resource occupies last symbols in the 1st slot to the (M−1)^{th} slot in time domain.

In a possible implementation, whether the first MCSt resource occupies or does not occupy the last symbol is determined based on a frequency domain resource occupied by the first MCSt resource in the last symbol.

In a possible implementation, in a case that the frequency domain resource occupied by the first MCSt resource in the last symbol is a resource block set, the first MCSt resource occupies the last symbol; or in a case that the frequency domain resource occupied by the first MCSt resource in the last symbol is part of frequency domain resources in a resource block set, the first MCSt resource does not occupy the last symbol, or the first MCSt resource occupies part of time domain resources in the last symbol.

In a possible implementation, the first MCSt resource meets one or more of the following: the first MCSt resource including a resource in time domain where a PSFCH resource is located; the first MCSt resource including a resource in frequency domain where a PSFCH resource is located; the first MCSt resource including a PSFCH resource; the first MCSt resource including no resource in time domain where a PSFCH resource is located; the first MCSt resource including no resource in frequency domain where a PSFCH resource is located; or the first MCSt resource including no PSFCH resource;

In a possible implementation, in a case that the first MCSt resource includes a resource in time domain where the PSFCH resource is located, the first MCSt resource further includes an AGC symbol used for reception of PSFCH, and/or a symbol occupied by a GP located before the AGC symbol in time domain.

In a possible implementation, whether the first MCSt resource includes a resource in time domain where the PSFCH resource is located is determined based on a first condition, and the first condition is determined based on one or more of following: whether the first MCSt resource includes a resource in frequency domain where the PSFCH resource is located; or whether feedback information exists on the PSFCH resource.

In a possible implementation, in a case that the first MCSt resource includes, in frequency domain, a resource in frequency domain where the PSFCH resource is located, the first MCSt resource does not include, in time domain, a resource in time domain where the PSFCH resource is located; and/or in a case that the first MCSt resource does not include, in frequency domain, a resource in frequency domain where the PSFCH resource is located, the first MCSt resource includes, in time domain, a resource in time domain where the PSFCH resource is located.

In a possible implementation, M is less than or equal to a configuration period of the PSFCH.

In a possible implementation, in a case that the first MCSt resource occupies one or more resource block sets in the sidelink resource pool in frequency domain, M is less than or equal to the configuration period of the PSFCH resource; in a case that the first MCSt resource occupies one or more resource blocks or interleaved PRBs in the sidelink resource pool in frequency domain, M is greater than the configuration period of the PSFCH resource.

FIG. 22 is a schematic diagram of a terminal device according to another embodiment of this application. A terminal device 2200 shown in FIG. 22 includes a processing unit 2210.

The processing unit 2210 is configured to perform resource selection in a sidelink resource pool based on a first parameter, where the first parameter is associated with a multiple consecutive slot transmission MCSt resource.

In a possible implementation, the first parameter includes a second parameter, the second parameter corresponds to a time domain resource granularity of the MCSt resource, and/or the second parameter is used for indicating that the MCSt resource occupies M consecutive slots in the sidelink resource pool in time domain, where M is a positive integer greater than 1.

In a possible implementation, the first parameter includes a third parameter, the third parameter corresponds to a frequency domain resource granularity of the MCSt resource, and/or the third parameter is used for indicating one of the following: the MCSt resource occupies one or more resource blocks or interleaved PRBs in the sidelink resource pool in frequency domain; the MCSt resource occupies one or more resource block sets in a resource pool in frequency domain; or the MCSt resource occupies one or more sub-channels in a resource pool in frequency domain.

In a possible implementation, the first parameter includes a plurality of sets of a second parameter and a third parameter, the plurality of sets of the second parameter and the third parameter correspond to a plurality of time-frequency domain resource granularities, and the plurality of time-frequency domain resource granularities are used for resource exclusion and/or resource selection in the sidelink resource pool.

In a possible implementation, the fourth parameter is a total quantity of first-type resources in a resource selection window for the sidelink resource pool, and the first-type resources have a time-frequency domain resource granularity of N resource blocks in M consecutive slots, where M is a positive integer greater than 1, and N is a positive integer greater than or equal to 1.

In a possible implementation, a total quantity of first-type resources in a first candidate resource set selected from the sidelink resource pool is determined based on a fifth parameter, the fifth parameter is used for indicating a threshold for a ratio of a total quantity of the first-type resources in a candidate resource set selected from the sidelink resource pool to a total quantity of the first-type resources in a resource selection window for the sidelink resource pool, and the first-type resources have a time-frequency domain resource granularity of N resource blocks in M consecutive slots, where M is a positive integer greater than 1, and N is a positive integer greater than or equal to 1.

In an optional embodiment, the processing unit 2110 may be a processor 2310. The terminal device 2100 may further include a transceiver 2330 and a memory 2320. Details are shown in FIG. 23.

In an optional embodiment, the processing unit 2210 may be a processor 2310. The terminal device 2200 may further include a transceiver 2330 and a memory 2320. Details are shown in FIG. 23.

FIG. 23 is a schematic structural diagram of a communications apparatus according to an embodiment of this application. Dashed lines in FIG. 23 indicate that a unit or module is optional. The apparatus 2300 may be configured to implement the methods described in the foregoing method embodiments. The apparatus 2300 may be a chip, a terminal device, or a network device.

The apparatus 2300 may include one or more processors 2310. The processor 2310 may support the apparatus 2300 in implementing the methods described in the foregoing method embodiments. The processor 2310 may be a general-purpose processor or a dedicated processor. For example, the processor may be a central processing unit (CPU). Alternatively, the processor may be another general-purpose processor, a digital signal processor (digital signal processor, DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 2300 may further include one or more memories 2320. The memory 2320 stores a program that may be executed by the processor 2310 to cause the processor 2310 to perform the methods described in the foregoing method embodiments. The memory 2320 may be separated from or integrated into the processor 2310.

The apparatus 2300 may further include a transceiver 2330. The processor 2310 may communicate with another device or chip through the transceiver 2330. For example, the processor 2310 may transmit data to and receive data from another device or chip through the transceiver 2330.

An embodiment of this application further provides a computer-readable storage medium for storing a program. The computer-readable storage medium may be applied to the terminal or the network device provided in the embodiments of this application, and the program causes a computer to perform the methods performed by the terminal or the network device in various embodiments of this application.

An embodiment of this application further provides a computer program product. The computer program product includes a program. The computer program product may be applied to the terminal or the network device provided in the embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to execute the methods performed by the terminal or the network device in various embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for sidelink communication, comprising:
determining, by a terminal device, a first multiple consecutive slot transmission (MCSt) resource, wherein the first MCSt resource occupies M consecutive slots in time domain, M is a positive integer greater than 1, and the first MCSt resource meets one of following in frequency domain:
the first MCSt resource occupying one or more resource blocks or interleaved resource blocks in a sidelink resource pool;
the first MCSt resource occupying one or more resource block sets in a sidelink resource pool; or
the first MCSt resource occupying one or more sub-channels in a sidelink resource pool.

2. The method according to claim 1, further comprising:
transmitting, by the terminal device, different transport blocks (TB) in the first MCSt resource in a case that the first MCSt resource comprises a physical sidelink feedback channel (PSFCH) resource.

3. A method for sidelink communication, comprising:
performing, by a terminal device, resource selection in a sidelink resource pool based on a first parameter, wherein the first parameter is associated with a multiple consecutive slot transmission (MCSt) resource.

4. The method according to claim 3, wherein the first parameter comprises a second parameter, the second parameter corresponds to a time domain resource granularity of the MCSt resource, and/or the second parameter is used for indicating that the MCSt resource occupies M consecutive slots in the sidelink resource pool in time domain, wherein M is a positive integer greater than 1.

5. The method according to claim 3, wherein the first parameter comprises a second parameter, the second parameter corresponds to a time domain resource granularity of the MCSt resource, the time domain resource granularity is a slot.

6. The method according to claim 4, wherein the performing, by the terminal device, resource selection in the sidelink resource pool comprises:
selecting, by the terminal device, the MCSt resource formed by N consecutive slots, wherein N is an integer equal to or greater than a value of the second parameter.

7. The method according to claim 6, wherein the performing, by the terminal device, resource selection in the sidelink resource pool comprises:
selecting, by the terminal device, the MCSt resource formed by N consecutive slots, wherein N is an integer equal to or greater than a value of the second parameter.

8. The method according to claim 3, wherein the first parameter comprises a third parameter, the third parameter corresponds to a frequency domain resource granularity of the MCSt resource, and/or the third parameter is used for indicating one of following:
the MCSt resource occupies one or more resource blocks or interleaved resource blocks in the sidelink resource pool in frequency domain;
the MCSt resource occupies one or more resource block sets in the sidelink resource pool in frequency domain; or
the MCSt resource occupies one or more sub-channels in the sidelink resource pool in frequency domain.

9. The method according to claim 4, wherein the first parameter comprises a third parameter, the third parameter corresponds to a frequency domain resource granularity of the MCSt resource, and/or the third parameter is used for indicating one of following:
the MCSt resource occupies one or more resource blocks or interleaved resource blocks in the sidelink resource pool in frequency domain;
the MCSt resource occupies one or more resource block sets in the sidelink resource pool in frequency domain; or
the MCSt resource occupies one or more sub-channels in the sidelink resource pool in frequency domain.

10. The method according to claim 3, wherein a total quantity of first-type resources in a first candidate resource set selected from the sidelink resource pool is determined based on a fifth parameter, the fifth parameter is used for indicating a threshold for a ratio of a total quantity of the first-type resources in a candidate resource set selected from the sidelink resource pool to a total quantity of the first-type resources in a resource selection window for the sidelink resource pool, and the first-type resources have a time-frequency domain resource granularity of N resource blocks in M consecutive slots, wherein M is a positive integer greater than 1, and N is a positive integer greater than or equal to 1.

11. A terminal device, comprising a processor configured to perform the method according to claim 1.

12. The terminal device according to claim 11, further comprising a transmitter configured to transmit different transport blocks (TB) in the first MCSt resource in a case that the first MCSt resource comprises a physical sidelink feedback channel (PSFCH) resource.

13. A terminal device, comprising a processor configured to:
perform resource selection in a sidelink resource pool based on a first parameter, wherein the first parameter is associated with a multiple consecutive slot transmission (MCSt) resource.

14. The terminal device according to claim 13, wherein the first parameter comprises a second parameter, the second parameter corresponds to a time domain resource granularity of the MCSt resource, and/or the second parameter is used for indicating that the MCSt resource occupies M consecutive slots in the sidelink resource pool in time domain, wherein M is a positive integer greater than 1.

15. The terminal device according to claim 13, wherein the first parameter comprises a second parameter, the second parameter corresponds to a time domain resource granularity of the MCSt resource, the time domain resource granularity is a slot.

16. The terminal device according to claim 14, wherein the processor is configured to:
select the MCSt resource formed by N consecutive slots, wherein N is an integer equal to or greater than a value of the second parameter.

17. The terminal device according to claim 16, wherein the processor is configured to:
select the MCSt resource formed by N consecutive slots, wherein N is an integer equal to or greater than a value of the second parameter.

18. The terminal device according to claim 13, wherein the first parameter comprises a third parameter, the third parameter corresponds to a frequency domain resource granularity of the MCSt resource, and/or the third parameter is used for indicating one of following:
the MCSt resource occupies one or more resource blocks or interleaved resource blocks in the sidelink resource pool in frequency domain;
the MCSt resource occupies one or more resource block sets in a resource pool in frequency domain; or
the MCSt resource occupies one or more sub-channels in a resource pool in frequency domain.

19. The method according to claim 14, wherein the first parameter comprises a third parameter, the third parameter corresponds to a frequency domain resource granularity of the MCSt resource, and/or the third parameter is used for indicating one of following:
the MCSt resource occupies one or more resource blocks or interleaved resource blocks in the sidelink resource pool in frequency domain;
the MCSt resource occupies one or more resource block sets in the sidelink resource pool in frequency domain; or
the MCSt resource occupies one or more sub-channels in the sidelink resource pool in frequency domain.

20. The terminal device according to claim 13, wherein a total quantity of first-type resources in a first candidate resource set selected from the sidelink resource pool is determined based on a fifth parameter, the fifth parameter is used for indicating a threshold for a ratio of a total quantity of the first-type resources in a candidate resource set selected from the sidelink resource pool to a total quantity of the first-type resources in a resource selection window for the sidelink resource pool, and the first-type resources have a time-frequency domain resource granularity of N resource blocks in M consecutive slots, wherein M is a positive integer greater than 1, and N is a positive integer greater than or equal to 1.
